(19) United States
(12) Patent Application Publication
(10) Pub. No.: US 2026/0273734 A1
(43) Pub. Date: Sep. 17, 2026

(54) SYSTEM AND METHOD FOR CONTROLLING A SMART GRIPPING APPARATUS

(71) Applicant: Nexera Robotics Corp., North Vancouver (CA)

(72) Inventors: Jingyang PENG, Surrey (CA); Michael CELIO, Coquitlam (CA); Thomas ROBINSON, Vancouver (CA); Sepehr Sheikholeslami, Surrey (CA); Carlo MENON, Zurich (ZH)

(21) Appl. No.: 19/243,684

(22) PCT Filed: Dec. 20, 2022
(86) PCT No.: PCT/CA2022/051873

§ 371 Date: Jun. 19, 2025

(51) Int. Cl. B25J 9/16; B25J 13/08; B25J 15/06

(52) U.S. Cl. CPC B25J 9/1612; B25J 9/1697; B25J 13/08; B25J 15/0616

(57) ABSTRACT

A gripper system and method or gripping an object using the gripper system for a robotic manipulator system are provided. The gripper system comprises: a chamber compartment comprising a deformable membrane wall, and at least one chamber compartment wall; a suction compartment delimited by a suction compartment wall; at least one pressure mechanism configured to modulate the pressure in the chamber compartment and a pressure in the suction compartment; at least one actuator for modulating a position of the at least one chamber compartment wall; at least one on-gripper sensor; at least one controller; and at least one image sensor configured to capture a geometry of an object to be picked. The method comprising the steps of using a captured geometry and a learning algorithm to determine a gripping configuration of the object to be picked.

### CROSS-REFERENCE TO RELATED APPLICATIONS

This application is a National Phase application that claims priority to and the benefit of the international PCT Patent Application No. PCT/CA2022/051873 entitled “SYSTEM AND METHOD FOR CONTROLLING A SMART GRIPPING APPARATUS”, filed on Dec. 20, 2020, the entirety of which are incorporated herein by reference.

### FIELD OF INVENTION

The embodiments described herein relates generally to methods for picking, gripping, grasping and holding a large variety of different items utilizing grippers that are capable of conforming to the items to be gripped and are mounted to at least one robotic manipulator or other positioning mechanism.

### BACKGROUND

As the need for gripping a large variety of items with a single gripper arises in fields such as manufacturing, agriculture, e-commerce, and logistics, multiple types of grippers with the mechanical capability of meeting at least part of such need have been developed.

However, such grippers usually have multiple operational parameters that ideally should be optimally chosen for each item to ensure a reliable grip. The method for choosing such operational parameters is challenging and not well defined. Also, the ways such grippers may approach the item to be picked, such as the point and the orientation, are also important factors determining the reliability of a grip. Therefore, it is desirable to develop methods for determining the operational parameters of such grippers and methods for determining how such grippers will approach the item to be picked.

### SUMMARY

The present disclosure will provide a number of methods for picking, gripping, grasping and holding a large variety of different items utilizing a picking system that employ a specific type of gripper that is capable of adapting to the shape of the item to be picked. The method for selecting the operation parameters for the gripper itself for gripping the item, the method for estimating and modulating the strength of a grip, the method for detecting unintentional item dropping, the method for detecting gripper faults, the method for determining a pick point on the item, and the method for determining the pick orientation are included.

### BRIEF DESCRIPTION OF THE DRAWINGS

FIG. 1 is diagram illustrating an overview of the picking system.

FIG. 2A is a state transition diagram for the picking system.

FIGS. 2B and 2C are state transition diagrams for the picking system.

FIGS. 3A to 3G are diagrams illustrating a configuration of the kind of gripper concerned in the present disclosure.

FIGS. 4A to 4C are diagrams illustrating a configuration of the modules in a picking system in the present disclosure.

FIGS. 5A and 5B are diagrams that illustrate the composition of a gripper state in the present disclosure.

FIGS. 6A and 6B are diagrams that illustrate the composition of a gripping configuration in the present disclosure.

FIGS. 7A to 7L are diagrams that illustrate the composition of the process parameters in a gripping configuration in the present disclosure.

FIGS. 8A and 8B are diagrams that illustrate the gripper gripping two kinds of items.

FIGS. 9A and 9B are diagrams that illustrate a gripping configuration used for gripping two kinds of items as a plot against time.

FIGS. 10A to 10G are flow charts of a method for determining a gripping configuration based on item geometry.

FIGS. 11A to 11C are flow charts of a method for determining a gripping configuration based on on-gripper sensor readings.

FIG. 12 is a diagram illustrating a default or baseline gripping configuration.

FIGS. 13A to 13E are flow charts of a method for determining a gripping configuration utilizing the process logic and the process logic parameters.

FIGS. 14A to 14E are diagrams that illustrate utilizing multiple methods for determining a gripping configuration to determine one gripping configuration.

FIGS. 15A and 15B are flow charts of a method for continuously updating the gripping configuration.

FIGS. 16A to 16C are diagrams illustrating a method for strengthening the grip.

FIGS. 16D and 16E are diagrams illustrating a method for detecting unintentional item dropping.

FIGS. 17A to 17C are diagrams illustrating a method for stopping the robotic manipulator once the gripper is in contact with the item to be picked.

FIGS. 18A to 18C are diagrams illustrating a method for determining a pick point.

FIG. 19A is a diagram illustrating the problem of determining a pick orientation from a point cloud with holes.

FIG. 19B is a diagram illustrating a method for determining a pick orientation.

### DETAILED DESCRIPTION

Described herein are methods for automating random item picking processes using at least one gripper that is attached to at least one robotic manipulator or other positioning mechanism.

### Picking System

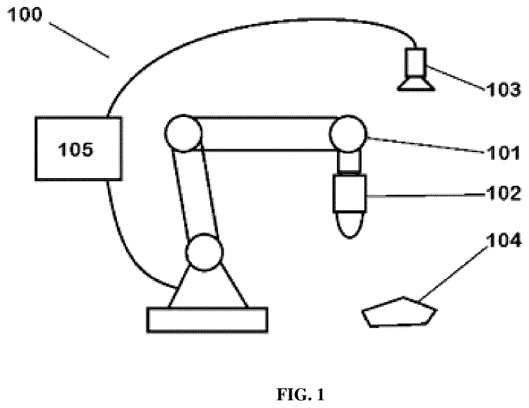

FIG. 1 is diagram illustrating an overview of the picking system. In one embodiment, a picking system 100 as in FIG. 1 has one or more robotic manipulator or other positioning mechanism 101. To at least one robotic manipulator or positioning mechanism, one or more gripper 102 is attached. One or more sensor 103 captures the geometry of the surface of the item 104 or a portion of the surface of the item 104 to be picked. And a picking system controller 105.

### Picking System States

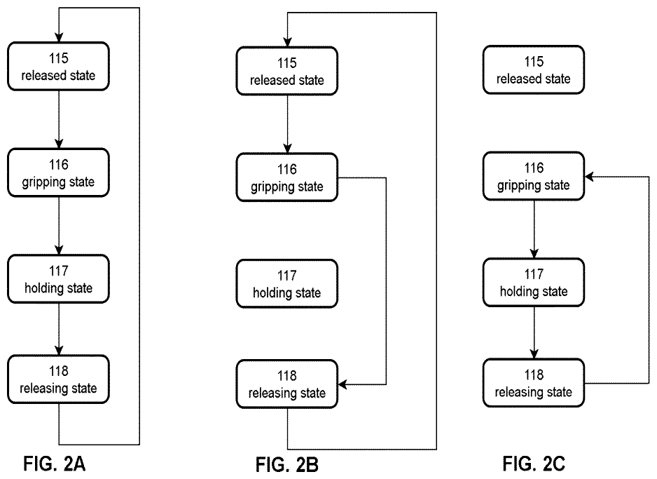

During normal operation, the picking system 100 can be in at least one of the following four normal operation states at a given time instance as in FIG. 2A: a released state 115, a gripping state 116, a holding state 117, and a releasing state 118.

According to the FIG. 1, During the released state 115, the gripper is not intended to grip, to hold, or to release an item. During the gripping state 116, a gripping process to be defined below is executed. During the holding state 117, the gripper is in a configuration that is supposed to hold an item. During the releasing state 118, a releasing process is executed.

FIG. 2A is a state transition diagram for the picking system. In normal operation, the four normal operation states transition between each other following the FIG. 2A. One or more of the normal operation states can be skipped.

FIGS. 2B and 2C are diagrams illustrating state transitions for the picking system when some of the states are skipped. For example, in FIG. 2B the holding state 117 is skipped, which for example is useful when an unsecure grip is detected during the gripping state 116, the gripping process may be stopped and switching to the releasing state 118 directly for executing the releasing process.

Also, for example in FIG. 2C, the released state 115 is skipped. Other states the picking system can be in may include one or more calibration states, one or more diagnostic states, one or more debug states and other states known to a person skilled in the art.

### Gripper Structure

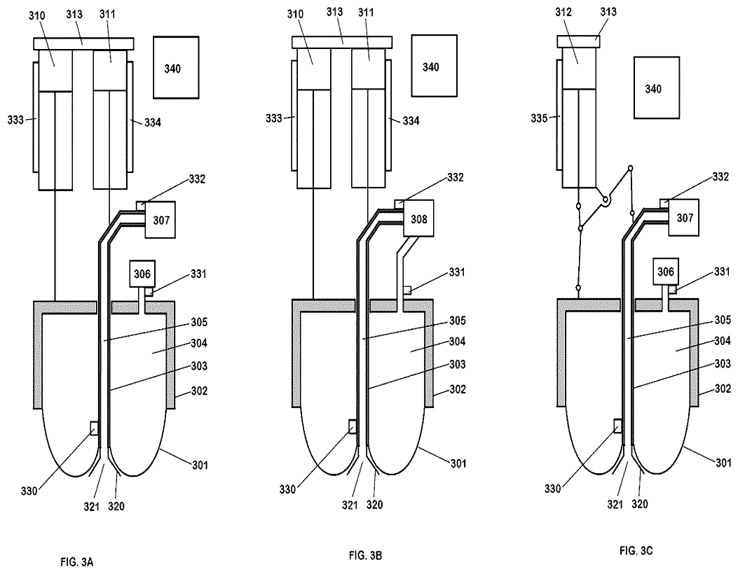

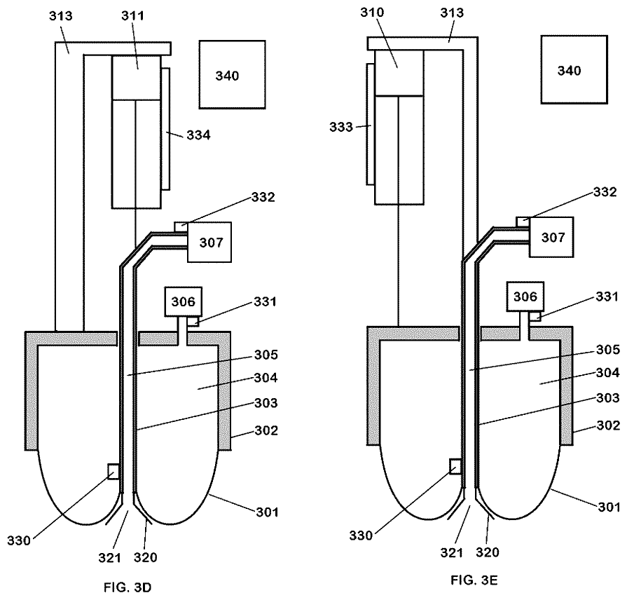

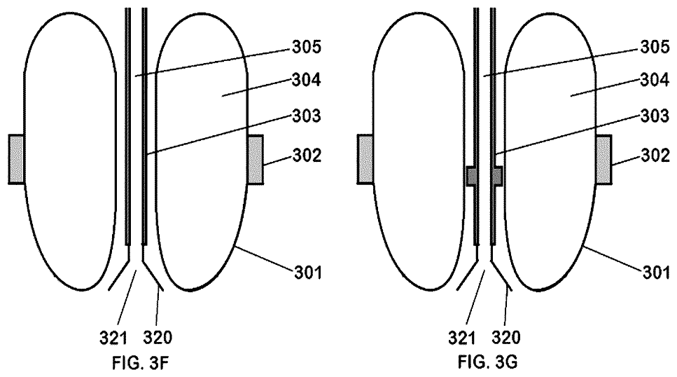

FIGS. 3A to 3E are diagrams illustrating a configuration of the kind of gripper concerned in the present disclosure. In one embodiment, the gripper 102 fitted to the robotic manipulator 101 takes one of the forms as shown in FIG. 3A, FIG. 3B, FIG. 3C, FIG. 3D, and FIG. 3E.

Such a gripper comprises a deformable membrane 301 mechanically connected to at least a chamber compartment wall 302 and a suction compartment wall 303. The space delimited by the membrane 301, the chamber compartment wall 302, and the suction compartment wall 303 is referred to as the chamber compartment 304. The space delimited by the suction compartment wall 303 is referred to as the suction compartment 305. A part 320 that doubles as a suction cup and a collar may be fitted to the end of the suction compartment wall 303. It is noted that the suction compartment 304 has an opening 321 to the environment at the end of the suction compartment wall 303.

The chamber compartment 304 can be pressurized or depressurized to a desired pressure value or to follow a desired pressure profile over time by a pressure mechanism 306. If the opening 321 of the suction compartment 304 is completely or partially sealed, possibly by the item being gripped, the pressure inside the suction compartment 305 can be pressurized or depressurized by a pressure mechanism 307 to a desired pressure value or to follow a desired pressure profile over time. If the opening 321 is not sealed, the pressure mechanism 307 can still try to pressurize or depressurize the suction compartment 304 to attempt to reach a desired pressure value or to attempt to follow a desired pressure profile over time, but may not actually be able to achieve the desired values.

It should be noted that the pressure mechanism 306 and the pressure mechanism 307 can be combined into a single pressure mechanism 308 as in FIG. 3B, or they can be separated as in FIG. 3A, FIG. 3C, FIG. 3D and FIG. 3E.

It should be noted that the pressure mechanism 306 and the pressure mechanism 307 can work in closed-loop mode. For example, the pressure mechanism automatically adjusts the fluid flow rate to and from the chamber so that the pressure in the chamber tracks a desired reference pressure profile as close as possible.

It should be further noted that the pressure mechanism 306 and the pressure mechanism 307 can also work in open-loop mode. For example, a pressure mechanism sets the fluid flow rate directly according to an input signal.

Actuators 310 and 311 are for changing the relative position between the chamber compartment wall 302 and the suction compartment wall 303. It should be noted that the actuators 310 and 311 can be combined into a single actuator 312 as shown in FIG. 3C, or they can be separated as in FIG. 3A, FIG. 3B, FIG. 3D and FIG. 3E.

According to FIGS. 3A to 3E, an on-gripper sensor 330 is used to measure the axial force applied to the suction compartment wall 303. An on-gripper sensor 331 is used for measuring the pressure inside the chamber compartment 304. An on-gripper sensor 332 is used for measuring the pressure inside the suction compartment 305. An on-gripper sensor 333 is used for measuring the position of the chamber compartment wall 302. An on-gripper sensor 334 is used for measuring the position of the suction compartment wall 303.

It should be noted that the sensors 333 and 334 can be combined into a single sensor 335 as shown in FIG. 3C. It should be noted that the chamber compartment wall 302 can be fixed to the gripper body 313 as in FIG. 3D. In this case, actuator 310 and sensor 333 are not needed.

It should be noted that the suction compartment wall 303 can be fixed to the gripper body 313 as in FIG. 3E. In this case, actuator 311 and sensor 334 are not needed.

A gripper controller 340 receives sensing information from the on-gripper sensors 330, 331, 332, 333, 334 and 335, controls the actuators 310, 311, and 312, and controls the pressure mechanisms 306, 307, and 308.

It should be noted that the gripper controller 340 may perform a part of the functions of the pressure mechanisms 306, 307, and 308. The gripper controller 340 may also perform a part of the functions of the actuators 310, 311, and 312.

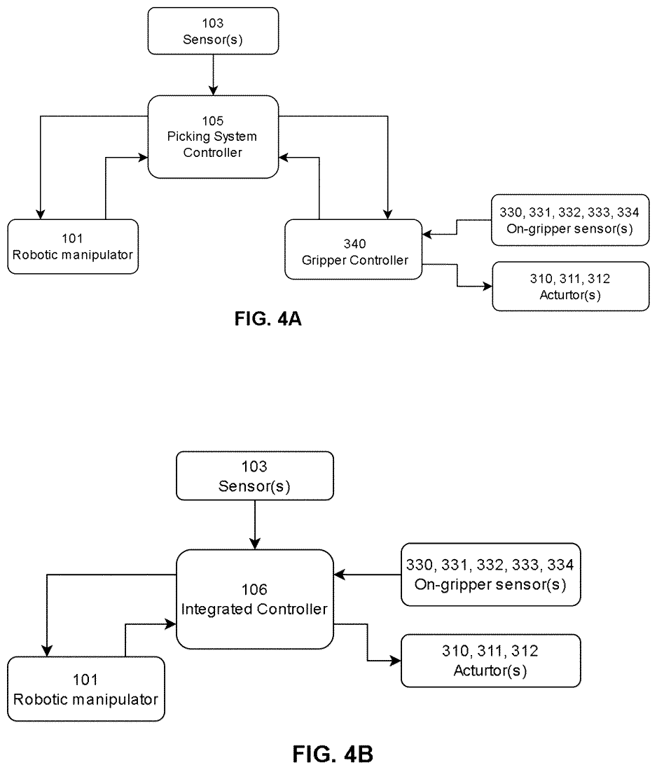

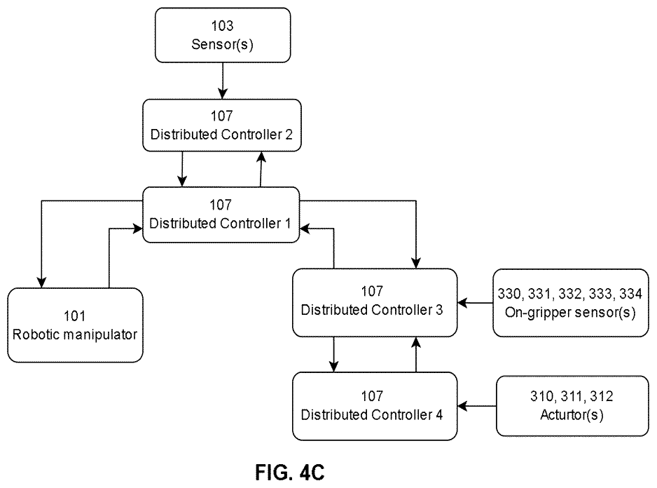

FIGS. 4A to 4C are diagrams illustrating a configuration of the modules in a picking system in the present disclosure. In one embodiment of the picking system 100 as shown in FIG. 4B, the gripper controller 340 and the picking system controller 105 are integrated as one single integrated controller 106.

In one embodiment of the picking system 100 as shown in FIG. 4A, the gripper controller 340 and the picking system controller 105 are separate units. In one embodiment of the picking system 100 as shown in FIG. 4C, the gripper controller 340 and the picking system controller 105 are divided into multiple distributed controllers 107.

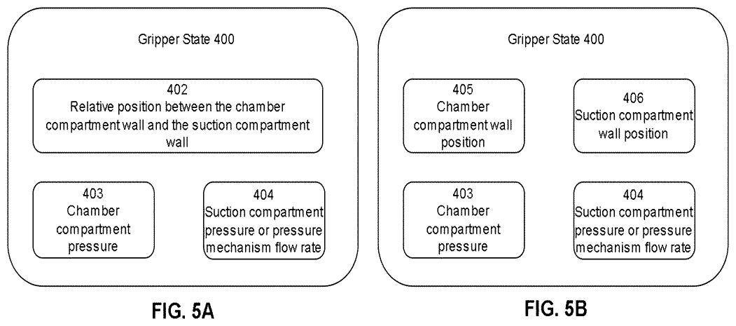

FIGS. 5A and 5B are diagrams that illustrate the composition of a gripper state in the present disclosure. In one embodiment, the gripper state 400 as shown in FIG. 5A is defined as comprising the relative position between the chamber compartment wall and the suction compartment wall 402, the chamber compartment pressure 403, and the suction compartment pressure or suction compartment pressure mechanism flow rate 404.

In one embodiment, the gripper state 400 as shown in FIG. 5B is defined as comprising the chamber compartment wall position 405, the suction compartment wall position 406, the chamber compartment pressure 403, and the suction compartment pressure or suction compartment pressure mechanism flow rate 404.

In another embodiment as shown in FIG. 3F, the gripper 102 fitted to the robotic manipulator 101 is different from those in FIG. 3A, FIG. 3B, FIG. 3C, FIG. 3D, and FIG. 3E that the deformable membrane 301 mechanically connected to at least a chamber compartment wall 302 but not connected to and not in contact with a suction compartment wall 303. So that the movement of the suction compartment wall 303 will not affect the shape or position of the deformable membrane 301. And the chamber compartment is delimited by the chamber compartment wall 302 and the deformable membrane 301. Notice that the gripper body 313, the actuators 310, 311, and 312, the on-gripper sensors 330, 331, 332, 333, 334 and 335, and the gripper controller 340 are not shown and they can be arranged in different ways as in FIG. 3A, FIG. 3B, FIG. 3C, FIG. 3D, and FIG. 3E.

In another embodiment as shown in FIG. 3G, the gripper 102 fitted to the robotic manipulator 101 is different from that in FIG. 3F that the deformable membrane 301 mechanically connected to at least a chamber compartment wall 302 but not connected to but in contact with a suction compartment wall 303. So that the movement of the suction compartment wall 303 will affect the shape or position of the deformable membrane 301 due to effects such as friction and mechanical interlocking. And the chamber compartment is delimited by the chamber compartment wall 302 and the deformable membrane 301. Notice that the gripper body 313, the actuators 310, 311, and 312, the on-gripper sensors 330, 331, 332, 333, 334 and 335, and the gripper controller 340 are not shown and they can be arranged in different ways as in FIG. 3A, FIG. 3B, FIG. 3C, FIG. 3D, and FIG. 3E.

### Gripping Process

A gripping process 600 for the gripper 102 comprises one or more of the following aspects, with all or any subset of them can execute in sequence or in parallel. The gripper controller 340 causes the pressure mechanism 306 or 308 to regulate the pressure in the chamber compartment 304 to follow a reference pressure profile over time. The gripper controller 340 causes the pressure mechanism 307 or 308 to regulate the pressure in the suction compartment 305 to follow a reference pressure profile over time.

Furthermore, the gripper controller 340 causes the pressure mechanism 307 or 308 to regulate the fluid flow in the suction compartment 305 to follow a reference maximum flow rate profile over time. The gripper controller 340 causes one or more actuators 310, 311, and 312 to move, with each actuator following one reference position profile over time.

The operations of the actuators 310 and 311 or 312 and the operations of the pressure mechanisms 306 and 307 or 308 results in the relative position changes between the chamber compartment wall 302 and the suction compartment wall 303 and the deformation of membrane 301, causing the membrane 301 to form around and therefore conform to the geometry of the item 104 being gripped. The attracting forces between the membrane 301 and the item 104 resulting from effects such as friction, vacuum pressure in the suction compartment 305, mechanical interlocking, Van de Waal force, electric static force, magnetic force, etc. cause the item 104 to be gripped by the gripper.

The gripper controller 340 receives sensing information from at least one or more on-gripper sensors 330, 331, 332, 333, 334, and 335.

Based on the sensing information received, the gripper controller 340 may stop the execution of one or more of the reference position profiles and reference pressure profiles based on the currently running process logic.

Furthermore, based on the sensing information received, the gripper controller 340 may modify the one or more of the reference position profiles and reference pressure profiles being executed or switch to follow one or more different reference position profiles and reference pressure profiles based on the currently running process logic.

Based on the sensing information received, the gripper controller 340 may modify the currently running process logic and switch to follow a different process logic. It should be noted that a gripping process may not be only used for gripping one or more items but may also be used for bringing the gripper to a specific gripper state 400.

### Gripping Configuration

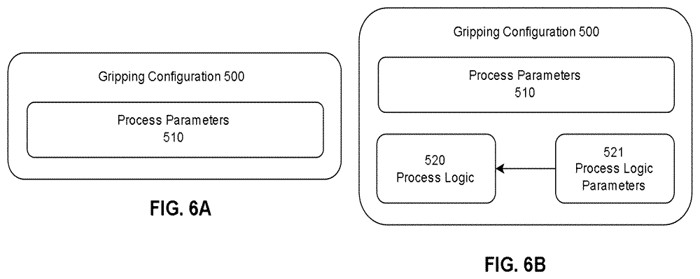

FIGS. 6A and 6B are diagrams that illustrate the composition of a gripping configuration in the present disclosure. A gripping configuration 500 comprises a set of process parameters 510 that completely defines the behavior of the gripper during a gripping process, as shown in an embodiment of the gripping configuration 500 depicted in FIG. 6A.

The set of process parameter 510 may include one or more of the following items:
Reference relative position profile over time between the chamber compartment wall and the suction compartment wall 511
Reference chamber compartment wall position profile over time 512
Reference suction compartment wall position profile over time 513
Reference chamber compartment pressure profile over time 514
Reference suction compartment pressure profile over time 515
Reference suction compartment maximum flow rate profile over time 516

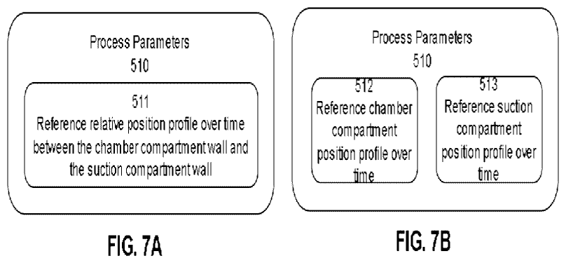

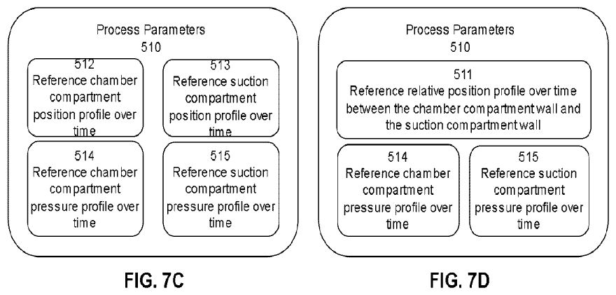

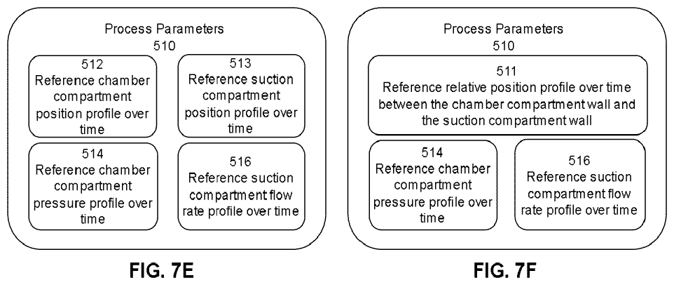

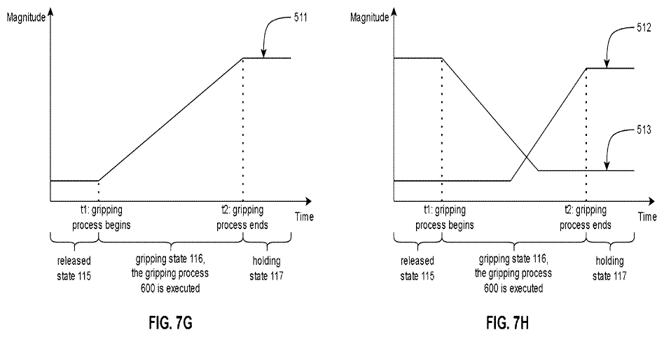

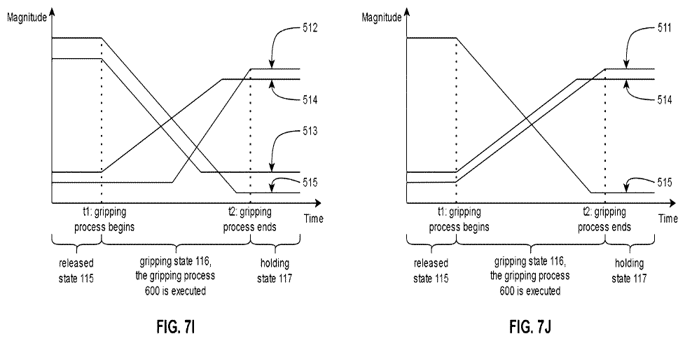

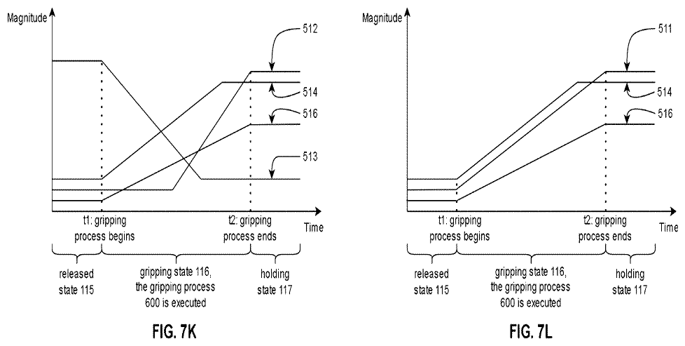

FIGS. 7A to 7L are diagrams that illustrate the composition of the process parameters in a gripping configuration in the present disclosure. In one embodiment of the process parameters 510 as shown in FIG. 7A and FIG. 7G, the set of process parameters 510 comprises a reference relative position profile over time between the chamber compartment wall and the suction compartment wall 511. In this case, the pressure of the chamber compartment 304 is not controlled. And the suction compartment 305 pressure or fluid flow is not controlled. FIG. 7G also represents an embodiment of the gripping configuration 500 containing only the process parameters 510 shown in FIG. 7A.

In one embodiment of the process parameters 510 as shown in FIG. 7B and FIG. 7H, the set of process parameters 510 comprises a reference chamber compartment wall position profile over time 512 and a reference suction compartment wall position profile over time 513. In this case, the pressure of the chamber compartment 304 is not controlled. And the suction compartment 305 pressure or fluid flow is not controlled. FIG. 7H also represents an embodiment of the gripping configuration 500 containing only the process parameters 510 shown in FIG. 7B.

In one embodiment of the process parameters 510 as shown in FIG. 7C and FIG. 71, the set of process parameters 510 comprises a reference chamber compartment wall position profile over time 512, a reference suction compartment wall position profile over time 513, a reference chamber compartment pressure profile over time 514, and a reference suction compartment pressure profile over time 515. FIG. 71 also represents an embodiment of the gripping configuration 500 containing only the process parameters 510 shown in FIG. 7C.

In one embodiment of the process parameters 510 as shown in FIG. 7D and FIG. 7J, the set of process parameters 510 comprises a reference relative position profile over time between the chamber compartment wall and the suction compartment wall 511, a reference chamber compartment pressure profile over time 514, and a reference suction compartment pressure profile over time 515. FIG. 7J also represents an embodiment of the gripping configuration 500 containing only the process parameters 510 shown in FIG. 7D.

In one embodiment of the process parameters 510 as shown in FIG. 7E and FIG. 7K, the set of process parameters 510 comprises a reference chamber compartment wall position profile over time 512, a reference suction compartment wall position profile over time 513, a reference chamber compartment pressure profile over time 514, and a reference suction compartment maximum flow rate profile over time 516. FIG. 7K also represents an embodiment of the gripping configuration 500 containing only the process parameters 510 shown in FIG. 7E.

In one embodiment of the process parameters 510 as shown in FIG. 7F and FIG. 7L, the set of process parameters 510 comprises a reference relative position profile over time between the chamber compartment wall and the suction compartment wall 511, a reference chamber compartment pressure profile over time 514, and a reference suction compartment maximum flow rate profile over time 516. FIG. 7L also represents an embodiment of the gripping configuration 500 containing only the process parameters 510 shown in FIG. 7F.

It should be noted that all the position and pressure profiles shown in FIG. 7G to FIG. 7L are for illustrative purposes only. In actual application, these profiles can take different shapes and can be continuously, discontinuously, discrete, zig-zag or other functions of time.

Anther embodiment of the gripping configuration 500 as shown in FIG. 6B also include a process logic 520 with its corresponding set of process logic parameters 521 that define a portion of the behavior of the gripper during the gripping process. In this case the set of process parameters 510 define the rest of the behavior of the gripper during the gripping process.

The process logic 520 may execute one or more of the following functions:
Modifying at least one reference position profile over time
Modifying at least one reference pressure profile over time
Switching from one reference position profile to another reference position profile over time
Switching from one reference pressure profile to another reference pressure profile over time
Stopping at least one of the currently running reference position profiles over time
Stopping at least one of the currently running reference pressure profiles over time
Modifying a part or the whole of the currently running process logic.
Switching to a different process logic.

One or more of the process logic functions described above can be triggered by the process logic itself. One or more of the process logic functions described above can be triggered by one or more external inputs. Such one or more external inputs can be the sensing information received and/or external commands.

The process logic parameters 521 affect the execution of at least some of the functions of the process logic 520. For a specific grip, during the gripping process the gripper controller 340 controls the pressure mechanisms 306 and 307 or 308 and the actuators 310 and 311 or 312 according to the gripping configuration 500 currently in effect.

A gripper can be set to different gripper configurations 500 in different gripping processes. A gripper can switch between different gripper configurations during a single gripping process. A gripping configuration can be effective during only one gripping cycle or can be effective over multiple gripping cycles. The number of possible gripping configurations for a specific gripper can be finite or infinite. The difference between two gripping configurations can be discontinuous or continuous.

The information regarding the gripping configurations 500 can be stored on the picking system controller 105, can be stored on the gripper controller 340, can be stored on both the picking system controller 105 and the gripper controller 340, can be stored on an integrated controller 106, can be stored on one or more distributed controllers 107, or can be stored at one or more external devices that can communicate with the picking system.

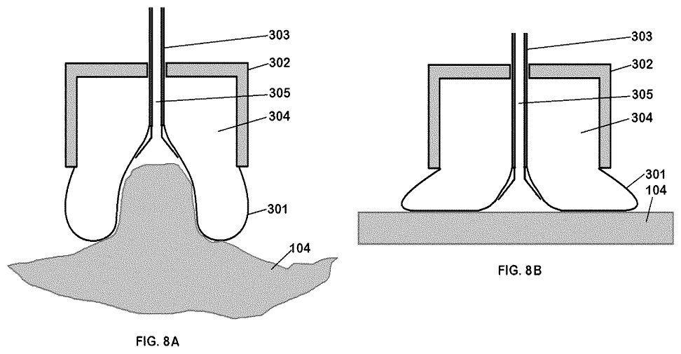

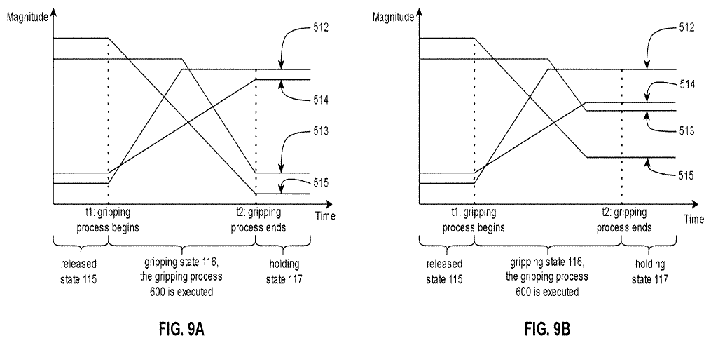

Different objects may require different gripping configurations or different set of gripping configurations to be picked up reliably. Therefore, one or more mechanisms are needed to determine the most suitable gripping configuration for a specific pick. To show this, FIGS. 8A and 8B are diagrams that illustrate the gripper gripping two kinds of items, with the item in FIG. 8A being more irregular, for example a stuffed animal toy, and the one in FIG. 8B being flat. FIGS. 9A and 9B are diagrams that illustrate the two possible gripping configurations used for gripping the two kinds of items shown in FIGS. 8A and 8B as plots against time.

For example, when gripping a more irregular item 104 as shown in FIG. 8A, it may be preferable to use a gripping configuration with process parameters only as shown in FIG. 9A. In FIG. 9A at the end of the gripping process 600 the gripping configuration causes a large relative position changes between the chamber compartment wall 302 and the suction compartment wall 303 and with a higher pressure inside the chamber compartment 304, such that the membrane 301 can pinch the item and draw all or part of it inside the chamber to produce enough friction for gripping.

On the other hand, when gripping a flat item as shown in FIG. 8B, it may be preferable to use a gripping configuration with process parameters only as shown in FIG. 9B. In FIG. 9B, at the end of the gripping process 600 it causes a moderate relative position changes between the chamber compartment wall 302 and the suction compartment wall 303 and with moderate pressure inside the chamber compartment 304, such that a large portion of the membrane 301 can contribute to forming a seal between the suction compartment 305 and the external environment, facilitating the flat plate 104 being picked up by the negative pressure inside the suction compartment 305.

### Gripping Configuration Determination by Image Sensor System

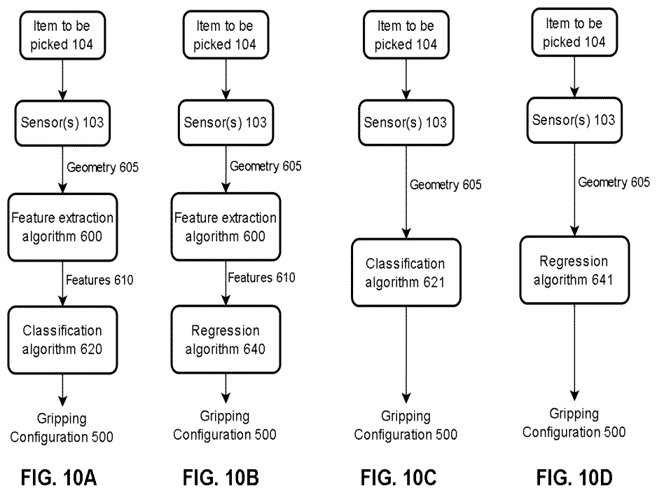

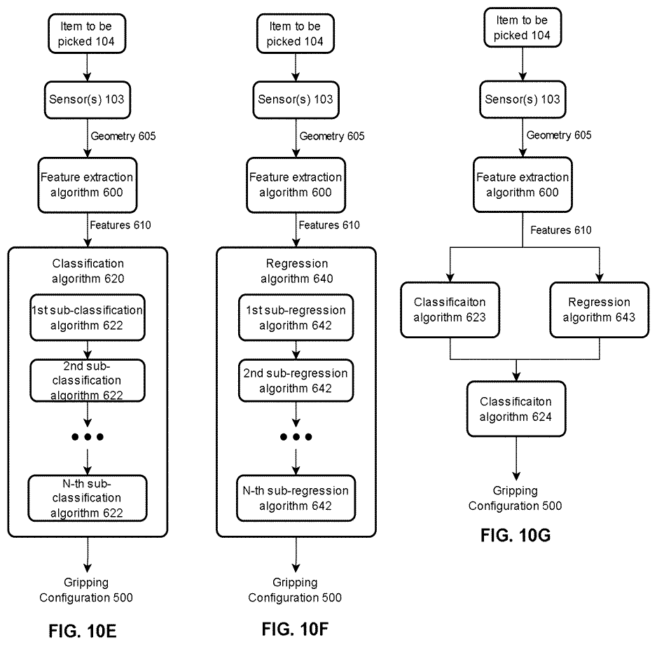

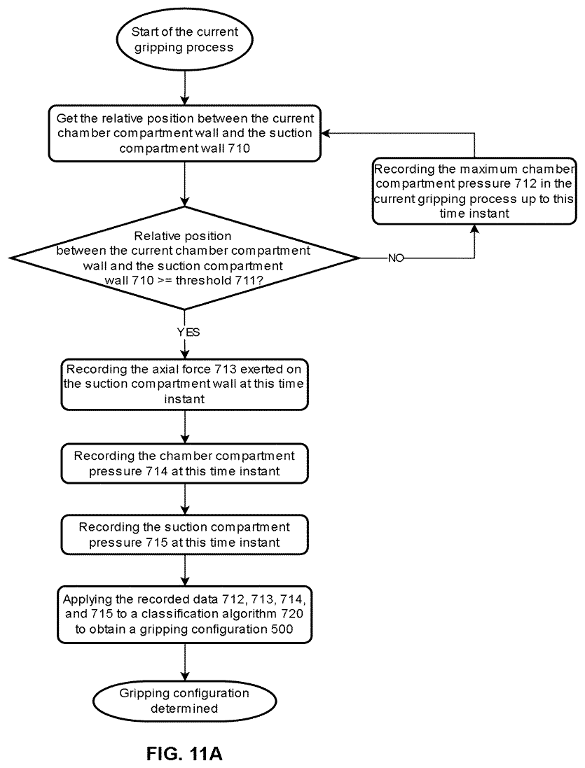

FIGS. 10A to 10G are flow charts of a method for determining a gripping configuration based on item geometry. In one embodiment, a mechanism for determining the most suitable gripping configuration for a specific pick is shown in FIG. 10A. The sensor(s) 103 comprises one or more image sensors that capture the geometry 605 of the surface of the item 104 or a portion of the surface of the item 104 to be picked.

A feature extraction algorithm 600 extracts features 610, including shape, material, porosity, corners, flatness, concavity, convexity, edges, weight, peaks and valleys, spatial frequencies, image reflections, smoothness, sharpness, depth variations, height from an average plane fit to the object or portion of the scene, resemblance between the whole or a part of the capture geometry to one or more predefined geometries, or automatically generated features from the geometry.

A classification algorithm 620 then classifies the features 610 based on their values into a finite number of classes 630, with each class corresponding to one gripping configuration 500 that is most suited to grip the kind of objects to which the object to be pick belong.

In one embodiment, a mechanism for determining the most suitable gripping configuration for a specific pick is shown in FIG. 10B. The sensor(s) 103 comprises one or more image sensors that capture the geometry of the surface of the item 104 or a portion of the surface of the item 104 to be picked.

A feature extraction algorithm 600 extracts features 610, including shape, material, porosity, corners, flatness, concavity, convexity, edges, weight, peaks and valleys, spatial frequencies, image reflections, smoothness, sharpness, depth variations, height from an average plane fit to the object or portion of the scene, resemblance between the whole or a part of the capture geometry to one or more predefined geometries, or automatically generated features from the geometry.

A regression algorithm 640 is applied to the value of the features 610 to determine a specific gripping configuration 500 among an infinite number of gripping configurations 500, so that the specific gripping configuration 500 is most suited to grip the kind of objects to which the object to be pick belong.

According to the disclosure, the algorithms 600, 620, and 640 may contain a traditional machine learning classifier, may contain a deep neural network classifier, may contain a traditional machine learning regressor, may contain a deep neural network regressor, may be obtain a priori through supervised learning, may be obtained a priori through imitation learning, or may be obtained a priori through reinforcement learning.

The algorithms 600, 620, and 640 can update itself based on information collected during the picking process. For example, a failed grip may indicate the feature extracted is not representing the object well, and/or the classification or regression result is wrong. Such information can be used to update the feature extraction algorithm 600, the classification algorithm 620, and the regression algorithm 640.

In one embodiment, a mechanism for determining the most suitable gripping configuration for a specific pick is shown in FIG. 10C, in which the algorithms 600 and 620 in FIG. 10A are combined as one single classification algorithm 621, for example, as a deep neural network classifier.

In one embodiment, a mechanism for determining the most suitable gripping configuration for a specific pick is shown in FIG. 10D, the algorithms 600 and 640 in FIG. 10B are combined as one single regression algorithm 641, for example, as a deep neural network regressor.

In one embodiment, a mechanism for determining the most suitable gripping configuration for a specific pick is shown in FIG. 10E, the classification algorithm 620 in FIG. 10A comprises more than one sub-classification algorithms 622.

In one embodiment, a mechanism for determining the most suitable gripping configuration for a specific pick is shown in FIG. 10F, the regression algorithm 640 in FIG. 10B comprises more than one sub-regression algorithms 642.

In one embodiment, a mechanism for determining the most suitable gripping configuration for a specific pick is shown in FIG. 10G, one regression algorithms 643 and one classification algorithms 623 are connected in parallel, then another classification algorithm 624 in series for finding the most suitable picking configuration 500.

It should be noted that one or more regression algorithms (643), and one or more classifications algorithms (623, 624) can be connected in other different ways, and they may or may not integrate the feature extraction algorithm 600, for finding the most suitable picking configuration 500.

### Gripping Configuration Determination by On-Gripper Sensor During the Initial Stage of the Gripping Process

In one embodiment, the on-gripper sensors comprise one sensor 333 for measuring the position of the chamber compartment wall, one sensor 334 for measuring the position of the suction compartment wall, or one sensor 335 for measuring the relative position between the chamber compartment wall and the suction compartment wall, one sensor 331 for measuring the pressure inside the chamber compartment, one sensor 332 measuring the pressure inside the suction compartment, and one sensor 330 measuring the axial force exerted on the suction compartment wall.

Given a default or baseline gripping configuration, after the gripping process is started and the gripper is in contact with the item to be gripped, the collected sensor data over time will contains information regarding the item being grasp. Therefore, is it possible to process the sensor data to obtain the information regarding the item being gripped and then determining the most suitable gripping configuration base on the item information.

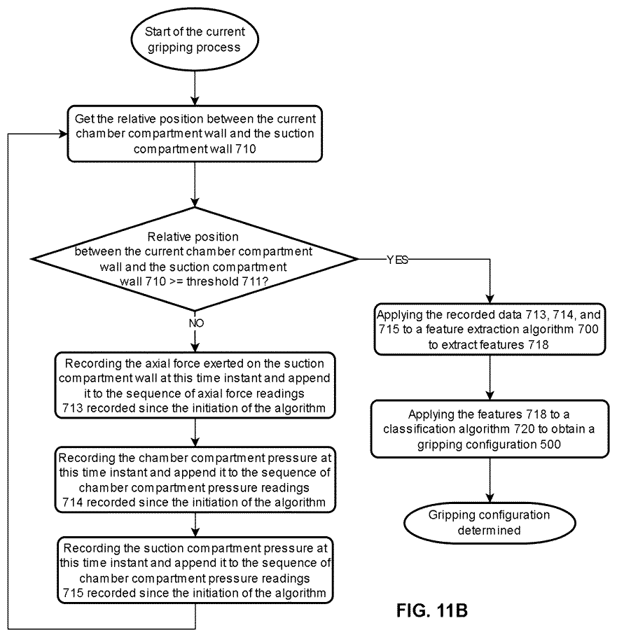

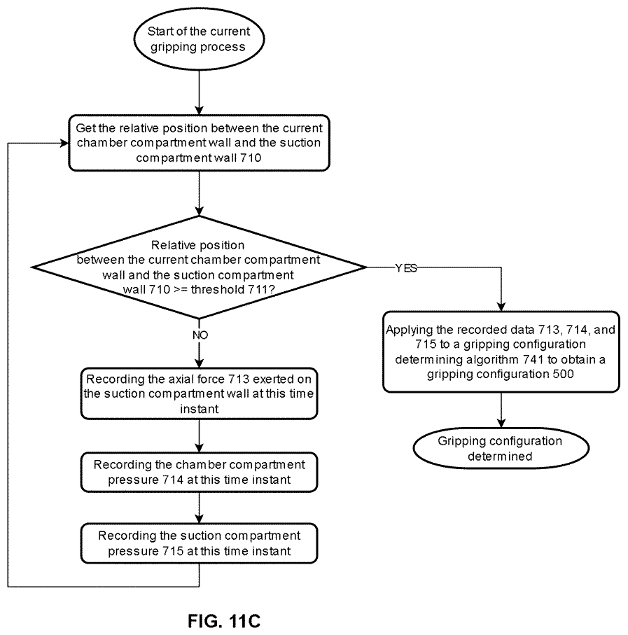

FIGS. 11A to 11C are flow charts of methods for determining a gripping configuration based on on-gripper sensor readings. An embodiment of a mechanism for determining the most suitable gripping configuration for a pick based on the idea of processing the on-gripper sensor data is shown in FIG. 11A.

According to FIG. 11A, the gripping process initiates by following a given gripping configuration. At each sampling interval, get the current relative position between the chamber compartment wall and the suction compartment wall 710 by reading the sensors 333 and 334 or the combination of the two 335. If the relative position between the current chamber compartment wall and the suction compartment wall 710 has not reached a predefined threshold 711 yet.

From the sensor 331 readings, determining and recording the maximum chamber compartment pressure 712 in the current gripping process (i.e., since the time when the gripping process started).

At the time instant when the current relative position between the chamber compartment wall and the suction compartment wall 710 reaches the predefined threshold 711.

The next step is to record one reading of the axial force 713 exerted on the suction compartment wall 303 from the sensor 330 reading. Thereafter, record one reading of the chamber compartment pressure 714 from the sensor 331 reading. Next, record one reading of the suction compartment pressure 715 from the sensor 332 reading.

Using one or more of the collected data 712, 713, 714, and 715 as features 718, a classification algorithm 720 classifies them as one of a finite number of classes, with each class corresponding to one gripping configuration 500 that is most suited to grip the kind of objects to which the object to be pick belong.

In another embodiment as shown in FIG. 11B, which is a variant of the embodiment shown in FIG. 11A, the mechanism for determining the most suitable gripping configuration initiates with the gripping process following a given gripping configuration.

At each sampling interval, get the current relative position between the chamber compartment wall and the suction compartment wall 710 by reading the sensors 333 and 334 or the combination of the two 335. If the relative position between the current chamber compartment wall and the suction compartment wall 710 has not reached a predefined threshold 711 yet.

The next step is to record one reading of the axial force exerted on the suction compartment wall 303 from the sensor 330 and append it to the sequence of axial force readings 713 collected since the initiation of the mechanism for determining the most suitable gripping configuration. Thereafter, record one reading of the chamber compartment pressure from the sensor 331 and append it to the sequence of chamber compartment pressure readings 714 collected since the initiation of the mechanism for determining the most suitable gripping configuration. And then record one reading of the suction compartment pressure from the sensor 332 and append it to the sequence of suction compartment pressure readings 715 collected since the initiation of the mechanism for determining the most suitable gripping configuration.

At the time instant when the current relative position between the chamber compartment wall and the suction compartment wall 710 reaches the predefined threshold 711. Using a feature extraction algorithm 700 to extract features 718 from one or more of the collected data, 713, 714, and 715, and then using a classification algorithm 720 to classify them as one of a finite number of classes, with each class corresponding to one gripping configuration 500 that is most suited to grip the kind of objects to which the object to be pick belong.

In another embodiment, which is a variant of the embodiment shown in FIG. 11A, is different from FIG. 11A that a regression algorithm 740 is used instead of the classification algorithm 720 to determine a specific gripping configuration 500 among an infinite number of gripping configurations 500, so that the specific gripping configuration 500 is most suited to grip the kind of objects to which the object to be pick belong.

In another embodiment, which is a variant of the embodiment shown in FIG. 11B, is different from FIG. 11B that a regression algorithm 740 is used instead of the classification algorithm 720 to determine a specific gripping configuration 500 among an infinite number of gripping configurations 500, so that the specific gripping configuration 500 is most suited to grip the kind of objects to which the object to be pick belong.

In another embodiment as shown in FIG. 11C, which is a variant of the embodiment shown in FIG. 11B, the algorithms 700 and 720 or 740 can be combined as one single gripping configuration determining algorithm 741.

According to the disclosure, the algorithms 700, 720, 740 and 741 may contain a traditional machine learning classifier, a deep neural network classifier, a traditional machine learning regressor and a deep neural network regressor. Furthermore, the algorithms 700, 720, 740 and 741 are obtained a priori through imitation learning or a priori through reinforcement learning.

The algorithms 700, 720, 740 and 741 can update itself based on information collected during the picking process. For example, a failed grip may indicate the classification or regression result is wrong. Such information can be used to update the classifiers and/or regressors.

### Gripping Configurations Determination by On-Gripper Sensor During the Gripping Process

FIGS. 9A and 9B are diagrams that illustrate two gripping configurations used for gripping two kinds of items as a plot against time. By comparing the gripping configurations shown in FIG. 9A and FIG. 9B, it can be noticed that the gripping configuration in FIG. 9B can be achieved by stopping the gripping process shown in FIG. 9A early at a specific time instant.

Therefore one way to achieve different gripping configurations is by stopping the execution of a default or baseline gripping configuration that contains process parameters only early at different time instants. And the method for determining when to stop the execution of a default or baseline gripping configuration for a specific pick becomes the mechanism for determining and achieving the most suitable gripping configuration 500 for that specific pick.

In some embodiments, such a gripping configuration determination mechanism is implemented by a process logic 520 along with its process logic parameters 521 associated with the default or baseline gripping configuration. This mechanism for determining the most suitable gripping configuration for a pick is also based on the idea of processing the on-gripper sensor data.

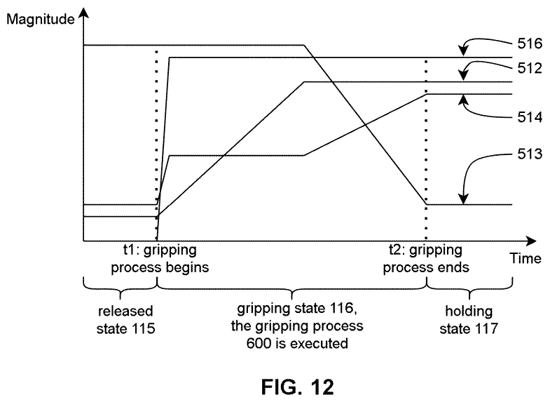

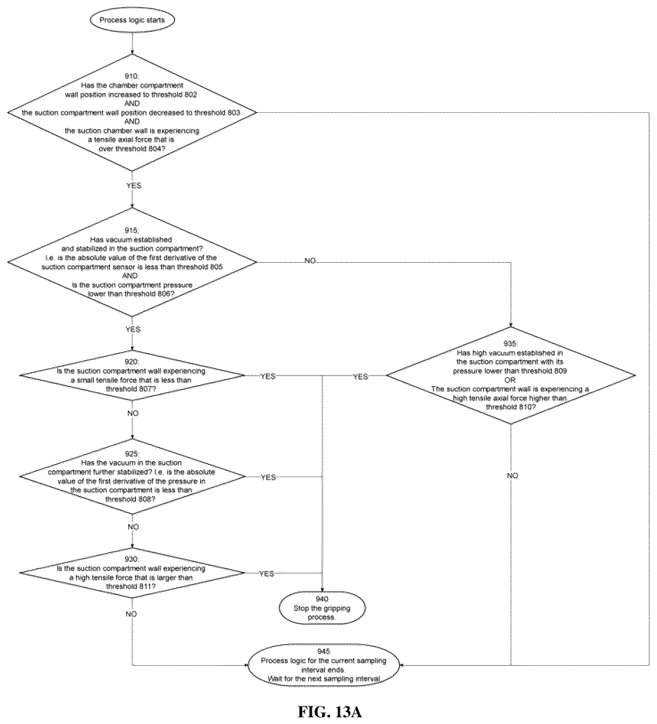

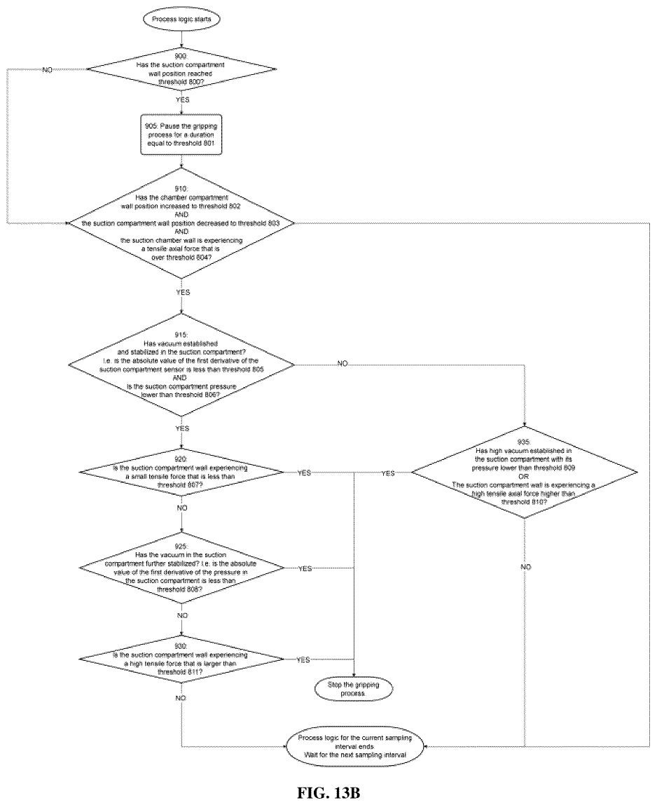

FIG. 12 is a diagram illustrating a default or baseline gripping configuration. In one of such embodiments employing the said kind of gripping configuration determination mechanism, the default or baseline gripping configuration is chosen as in FIG. 12 and described herein. Initially, the chamber compartment wall is positioned at the end of its stroke that is the closest to the proximal end of the gripper. The suction compartment wall is positioned at the end of its stroke that is the closest to the distal end of the gripper.

According to FIG. 12, The chamber compartment pressure is at a low positive value, and the maximum flowrate though the suction compartment is set to zero. Once the gripping process started, the maximum flowrate though the suction compartment is set to a specific value. The chamber compartment wall moves towards the distal end of the gripper. The suction compartment wall stays still. And the desired chamber compartment pressure is set to a set value. Once the chamber compartment wall reaches a specific position, it stops moving and the suction compartment wall starts to move towards the proximal end of the gripper. The desired chamber compartment pressure is set to increase with the increment proportional to the displacement of the suction compartment wall. The baseline gripping configuration ends when the suction compartment wall reaches a specific position.

In the same embodiment, the process logic parameters 521 comprise the following:
Initial chamber compartment wall position threshold 802
Initial suction compartment wall position threshold 803
Initial suction compartment wall axial force threshold 804
First suction compartment pressure derivative threshold 805
First suction compartment pressure threshold 806
First suction compartment wall axial force threshold 807, which is bigger than the initial suction compartment wall axial force threshold 804
Second suction compartment pressure derivative threshold 808, which is smaller than the first suction compartment pressure derivative threshold 805
Second suction compartment pressure threshold 809, which is smaller than the first suction compartment pressure threshold 806
Second suction compartment wall axial force threshold 810, which is bigger than the initial suction compartment wall axial force threshold 804.
Third suction compartment wall axial force threshold 811, which is bigger than the first suction compartment wall axial force threshold 807.

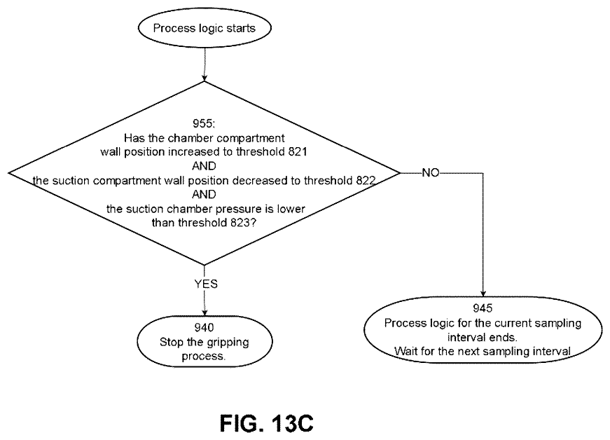

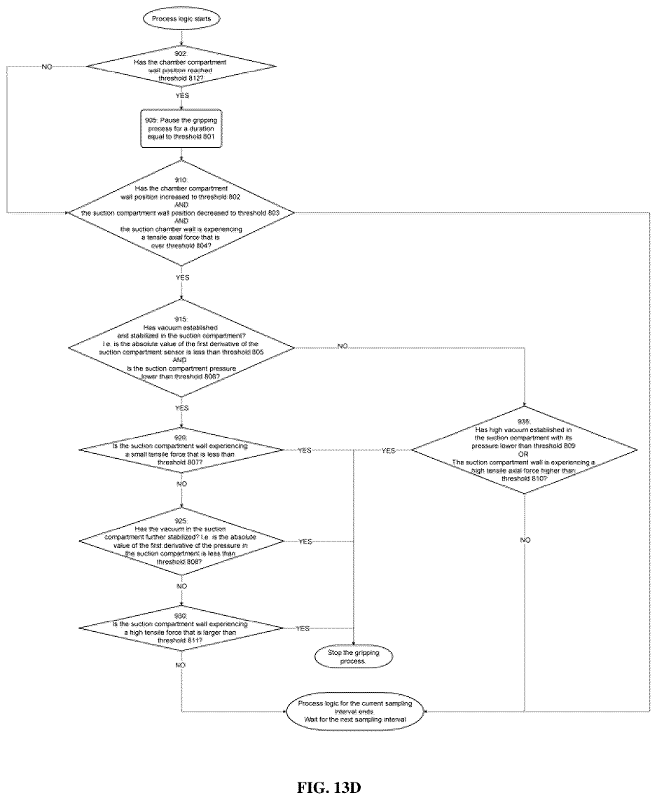

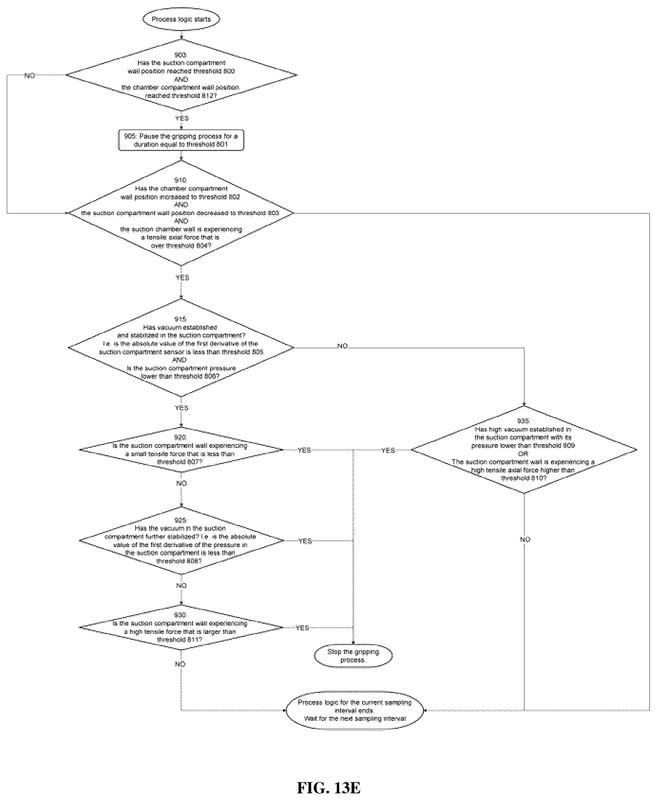

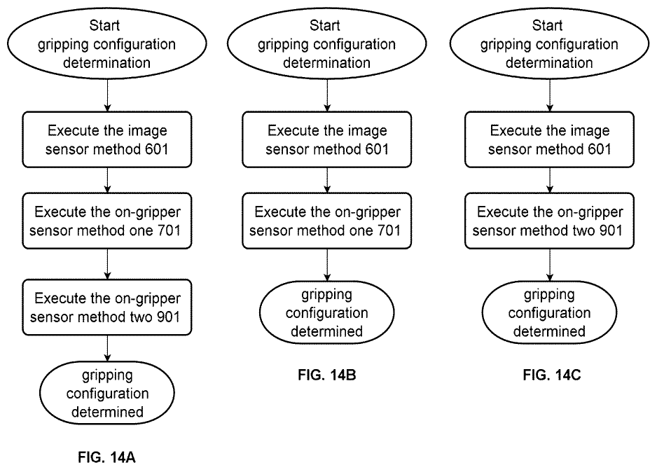

FIGS. 13A to 13E are flow charts of a method for determining a gripping configuration utilizing the process logic and the process logic parameters. In the same embodiment, the process logic is executed once during each sampling interval, and it is shown in FIG. 13A with explanation given below.

According to FIG. 13A, at the beginning of the process logic, the first decision block 910 states that the chamber compartment wall and the suction compartment wall must have moved past thresholds 802 and 803 respectively and the suction compartment wall must be in tension greater than threshold 804 before the other conditions for stopping the gripping process can be checked. This imposes a set of necessary conditions for stopping the gripping process, preventing it from happening too early. So that once such conditions are met, the gripper should be in such a gripper state that a sufficient portion of the membrane can conform to the item to be gripped, therefore improving the reliability of the grip.

If the decision block 910 returns true, the decision block 915 ensues. Decision block 915 checks if the pressure in the suction compartment is stabilizing, specifically by checking if the absolute value of the first derivative of the suction compartment pressure reading is smaller than threshold 805. Decision block 915 also checks if the pressure in the suction compartment produces a vacuum that is moderately strong, specifically stronger than threshold 806.

If not both conditions in decision block 915 being true, it means that a seal could be being formed, or the item could be very leaky, and decision block 915 outputs false. If this is the case, decision block 935 firstly checks if the pressure in the suction compartment is already a strong vacuum despite it is not stabilized yet, specifically, it is stronger than threshold 809. This is usually the case if a seal is suddenly formed over non-leaking items in the current sampling interval, and it indicates there is enough attraction force between the item and the gripper generated for a good grip, and block 940 will be invoked to stop the execution of the default or baseline gripping configuration, resulting in an effectively new gripping configuration.

Decision block 935 also checks if the suction compartment wall is under a big tension, specifically bigger than threshold 810. Considering the implications of the output of the previous decision block 915, this condition in decision block 935 is usually met when the item is hard and very leaky, for example a hairbrush is being gripped by its bristles, and usually under this circumstance the membrane will be already firmly gripping the item. Therefore block 940 will be invoked to stop the execution of the default or baseline gripping configuration, resulting in an effectively new gripping configuration.

If both conditions in decision block 915 are checked to be true, it means the item being pick is not very leaky and the vacuum is somewhat stabilized, and decision block 915 outputs true. In this case further decisions need to be made to determined when to stop the execution of the default or baseline gripping configuration.

Decision block 920 makes the first of such decisions. Decision block 920 checks if the suction compartment wall is experiencing a tensile force that is small enough, specifically smaller than threshold 807, or even still in compression. If true, also consider the implications of the output of the previous decision block 915 being true, meaning that we have not insignificant vacuum developed and moderately stable in the suction chamber. The situation here usually indicates that a hard but not very leaky item is in grasp, though other kind of items may also apply. And block 940 can be invoked to stop the execution of the default or baseline gripping configuration, resulting in an effectively new gripping configuration.

If decision block 920 outputs false, that means the axial tensile force on the suction compartment wall is not insignificant. In this case, the pressure in the suction compartment is check again by decision block 925. Decision block 925 checks if the pressure in the suction compartment is already very stable, specifically check if the absolute value of the first derivative of the pressure in the suction compartment is small than threshold 808, which is in turn smaller than threshold 805. If true, it usually indicates that a soft but not leaky item is in grasp, for example a bag. And block 940 can be invoked to stop the execution of the default or baseline gripping configuration, resulting in an effectively new gripping configuration.

If decision block 925 outputs false, it means vacuum is somewhat stabilized but not very stable yet and it is of moderate strength, but the axial tensile force on the suction compartment wall is not insignificant. In this case, check the axial tensile force on the suction compartment wall again with decision block 930 to see how significant it is, specifically, check if the axial tensile force is bigger than threshold 811. If true, the item could be hard but somewhat leaky, and a strong enough grasp has been formed. And block 940 can be invoked to stop the execution of the default or baseline gripping configuration, resulting in an effectively new gripping configuration.

If after all the decision blocks 910, 915, 920, 925, 930, and 935 are executed but block 940 is not invoked, it means a good grasp has not been form yet. In this case the block 945 is invoked to end the process logic for the current sampling interval and wait for the next sampling interval.

In another embodiment (FIG. 13B), additional process parameters are presented. According to FIG. 13B, the first suction compartment wall position threshold 800, and pause duration threshold 801 are introduced and the process logic is shown in FIG. 13B, which is a modification of the process logic shown in FIG. 13A with decision blocks 900 and 905 added to introduce a period of pausing 801 once the suction compartment wall reaches the position represented by threshold 800.

This pausing stage is introduced for allowing time for certain controlled variables as well as sensor outputs to stabilized so that transient effects will not affect the decisions made in decision blocks 910, 915, 920, 925, 930, and 935.

In another embodiment (FIG. 13D), additional process parameters are also presented. First chamber compartment wall position threshold 812 and pause duration threshold 801 are introduced and the process logic is shown in FIG. 13D, which is a modification of the process logic shown in FIG. 13A with decision blocks 902 and 905 added to introduce a period of pausing 801 once the chamber compartment wall reaches the position represented by threshold 812. This pausing stage is introduced for allowing time for certain controlled variables as well as sensor outputs to stabilized so that transient effects will not affect the decisions made in decision blocks 910, 915, 920, 925, 930, and 935.

In another embodiment (FIG. 13E), additional process parameters are also presented. First suction compartment wall position threshold 800, first chamber compartment wall position threshold 812, and pause duration threshold 801 are introduced.

The process logic is shown in FIG. 13E, which is a modification of the process logic shown in FIG. 13A with decision blocks 903 and 905 added to introduce a period of pausing 801 once the suction compartment wall reaches the position represented by threshold 800 and the chamber compartment wall reaches the position represented by threshold 812. This pausing stage is introduced for allowing time for certain controlled variables as well as sensor outputs to stabilized so that transient effects will not affect the decisions made in decision blocks 910, 915, 920, 925, 930, and 935.

In another embodiment, the process logic is shown in FIG. 13C with the following set of process logic parameters:
Chamber compartment wall position threshold 821
Suction compartment wall position threshold 822
Suction compartment pressure threshold 823

The process logic specifies that once the chamber compartment wall and the suction compartment wall both have moved passed the thresholds 821 and 822, if a strong vacuum is detected inside the suction compartment, specifically the suction compartment pressure is lower than threshold 823, block 940 should be invoked to stop the execution of the default or baseline gripping configuration, resulting in an effectively different gripping configuration. This process logic is useful for example in the case that a soft and leaky item is expected, so a first gripping configuration with the gripper state at the end of the gripping process resembling FIG. 8A is assigned. But during the gripping process it is detected that the item is in fact not leaky and a second gripping configuration with a gripper state at the end of the gripping process resembling FIG. 8B is more suitable. The process logic in FIG. 13C helps to stop the execution of a default or baseline gripping configuration early to achieve effectively the second gripping configuration.

In the following, the gripping configuration determination mechanisms depicted in FIG. 10A to FIG. 10G are referred to as the image sensor method 601. The gripping configuration determination mechanisms depicted in FIG. 11A to FIG. 11C are referred to as the on-gripper sensor method one 701. The gripping configuration determination mechanisms depicted in FIG. 12 to FIG. 13C are referred to as the on-gripper sensor method two 901. The methods 601, 701, and 901 can be executed during the released state 115 and the gripping state 116.

It should be noted that the image sensor method 601, the on-gripper sensor method one 701, and the on-gripper sensor method two 901 can be use alone or can be combined in different ways to improve the chance of determining the most suitable gripping configuration for a pick.

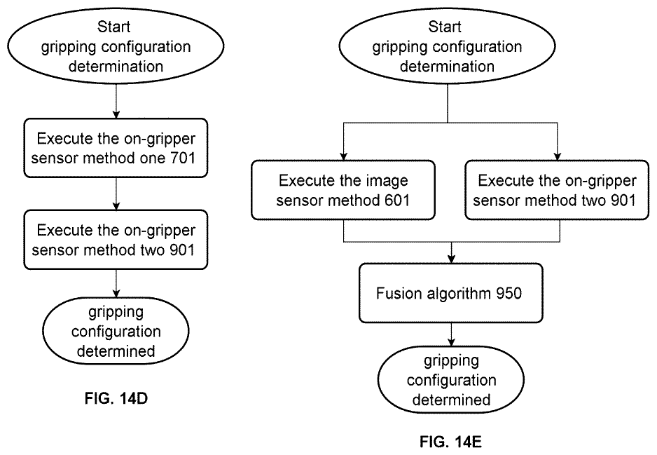

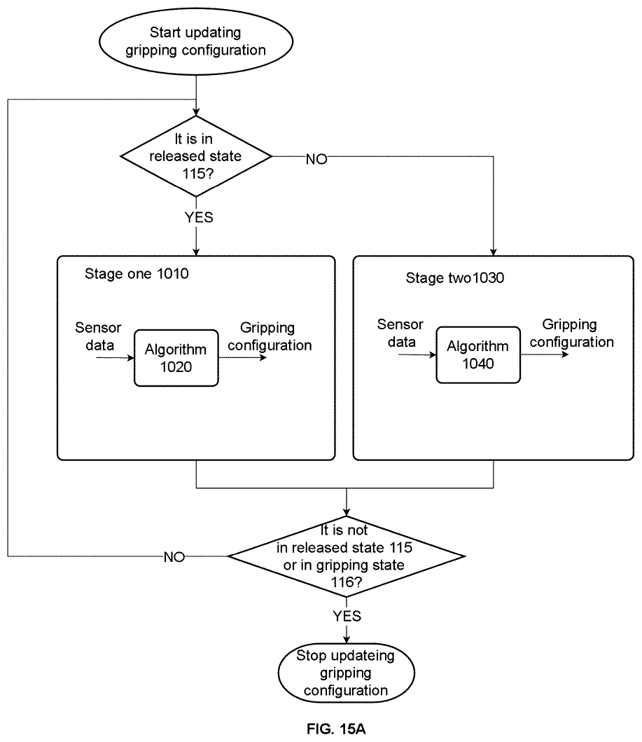

FIGS. 14A to 14E are diagrams that illustrate multiple methods for combining a number of different methods for determining a gripping configuration to determine one gripping configuration. In an embodiment shown in FIG. 14A the image sensor method 601, on-gripper sensor method one 701, and the on-gripper sensor method two 901 are used in series to determine the gripper configuration.

It should be noted that, the output of the method that is executed earlier may limit the scope of the output or the detailed implementation of the method that is executed later. For example, the outputs of the methods 601 and 701, which are executed earlier, may affect the choice of the baseline gripping configuration, the process logic, and the process logic parameters for method 901, which is executed later. On the other hand, the output of the method that is executed later may override the output of the method that is executed earlier. For example, if method 601, which is executed earlier, determined that a gripping configuration that is most suited for non-leaking items should be chosen, but method 901, which is executed later, determined that the item is leaky and a different gripping configuration should be chosen, the output of method 901 can override the output of method 601.

In an embodiment shown in FIG. 14B, the image sensor method 601 and the on-gripper sensor method one 701 are used in series to determine the gripper configuration.

In an embodiment shown in FIG. 14C, the image sensor method 601 and the on-gripper sensor method one 901 are used in series to determine the gripper configuration.

In an embodiment shown in FIG. 14D, the on-gripper sensor method one 701 and the on-gripper sensor method two 901 are used in series to determine the gripper configuration.

In an embodiment shown in FIG. 14E, image sensor method 601 and the on-gripper sensor method two 901 are used in parallel to determine the gripper configuration. In this case, a fusion algorithm 950 is needed to determine the actual gripping configuration to be used as the methods 601 and 901 may output different results. For example, algorithm 950 can be a simple majority vote mechanism, weighted majority vote mechanism, a simple average and a weighted average.

### Gripping Configuration Continuous Update

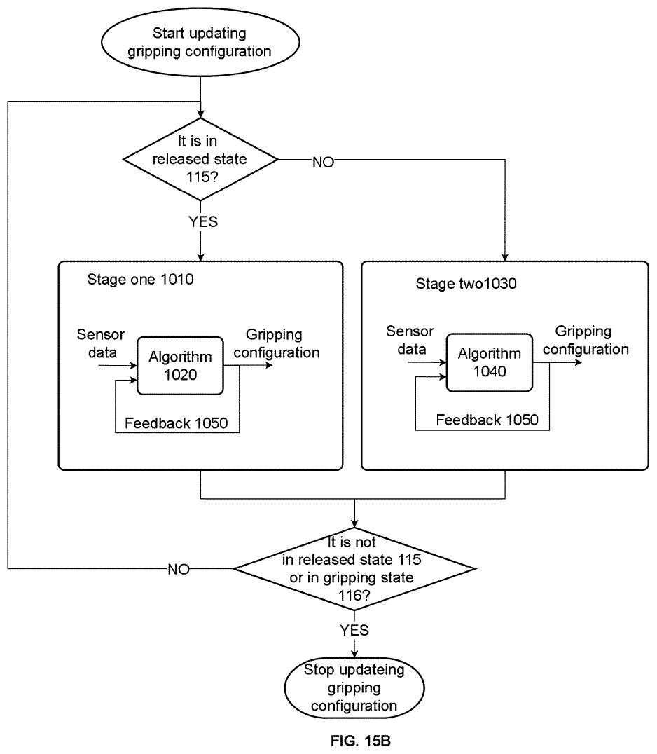

FIGS. 15A and 15B are flow charts of a method for continuously updating the gripping configuration. In one embodiment as shown in FIG. 15A, a mechanism for continuously updating the gripping configuration is presented. Specifically, the gripping configuration is continuously updated throughout the released state 115 and the gripping state 116 until the gripping process ends. This process is divided into two stages.

Stage one 1010 works during the released state 115 when the gripping process has not started yet. In stage one, sensor 103 and possible one or more additional on-gripper sensor 336 capable of remote sensing continuously gather information about the item, and the information is passed to an algorithm 1020 to update the gripping configuration. For example, sensors 103 and 336 are cameras. Sensor 103 may be mounted on the robotic manipulator 101 and sensor 336 may be mounted on the gripper 102. During the released state 115, the robotic manipulator movement may bring the sensors 103 and 336 to different distances from the item 104 to be picked and at different viewing direction, therefore increasingly complete geometric information can be collected about the item 104 during the released state 115. By feeding the constantly updating collected geometric information to the algorithm 1020 repeatedly, a continuously refined gripping configuration output can be obtained.

Stage two 1030 works during the gripping state 116 when the gripping process has started. It works similar to stage one 1020 except that additional data from on-gripper sensors 330, 331, 332, 333, 334, 335, and 336 can also be gather and passed to an algorithm 1040 to update the gripping configuration.

In one embodiment as shown in FIG. 15B, feedbacks 1050 are added so that the current gripping configuration output does not only depend on the current sensor information but also depend on one or more previous gripping configuration outputs. This may help, for example, preventing outliner gripping configuration from being adopted.

### Machine Learning Methods for Gripping Configuration Determination, Pick Point Determination, Pick Orientation Determination

In one embodiment, one or more of the gripping system controller 105, the gripper controller 340, and the distributed controller 107 at least utilize one or more models obtained by one or more machining learning approaches to determine one or more of the following items including a gripping configuration 500, a pick point 1203, and a pick orientation 1206, witch minimizes gripping failures, minimizes damage to the item 104, maximizes speed, and maximizes the service life of the gripper 102. An initial model or model structure can be provided to the learning process as a starting point, or a model-free approach can be used.

In one embodiment, one or more of the gripping system controller 105, the gripper controller 340, and the distributed controller 107 at least partially utilize one or more models obtained at least partially by imitation learning to determine one or more of the following items including a gripping configuration 500, a pick point 1203, and a pick orientation 1206. The learning dataset is obtained from demonstrations.

In one embodiment, such demonstrations for collecting data for imitation learning are at least partially performed physically with the physical griper gripping physical items.

In one embodiment, such demonstrations for collecting data for imitation learning are at least partially performed virtually in a virtual environment through simulating a virtual gripper gripping virtual items. The virtual environment has all necessary physics laws built in so that it can simulate the gripper operation and the interaction between the gripper and the environment. Aspects simulated including but not limited to gripper movements, chamber compartment pressure, suction compartment pressure, membrane deformation, membrane stress, dynamics, statics, friction, gravity, Van der Waals force between the membrane and the item. Among them, the membrane deformation and the membrane stress can be simulated using one or more of the following hyperelastic material models: the Fung model, the Mooney-Rivlin model, the Ogden model, the Polynomial model, the Saint Venant-Kirchhoff model, the Yeoh model, the Marlow model, the Arruda-Boyce model, the Neo-Hookean model, the Buche-Silberstein model, the Gent model, and the Van der Waals model.

In one embodiment, such demonstrations for collecting data for imitation learning are performed many times, preferably over one million times, to obtain a big dataset for better learning result. In one embodiment, one or more of the gripping system controller 105, the gripper controller 340, and the distributed controller 107 at least partially utilize one or more models obtained at least partially by reinforcement learning to determine one or more of the following items including a gripping configuration 500, a pick point 1203, and a pick orientation 1206, or a gripping policy, that maximizes a reward function that aims at minimizing gripping failures, minimizing damage to the item 104, maximizing speed, and maximizing the service life of the gripper 102.

In one embodiment, the reinforcement learning process is conducted physically with the physical gripper gripping physical items. In one embodiment, the reinforcement learning process is conducted virtually in a virtual environment through simulating a virtual gripper gripping virtual items. The virtual environment has all necessary physics laws built in so that it can simulate the gripper operation and the interaction between the gripper and the environment. Aspects simulated including but not limited to gripper movements, chamber compartment pressure, suction compartment pressure, membrane deformation, the membrane stress, dynamics, statics, friction, gravity, Van der Waals force between the membrane and the item. Among them, the membrane deformation and the membrane stress can be simulated using one or more of the following hyperelastic material models: the Fung model, the Mooney-Rivlin model, the Ogden model, the Polynomial model, the Saint Venant-Kirchhoff model, the Yeoh model, the Marlow model, the Arruda-Boyce model, the Neo-Hookean model, the Buche-Silberstein model, the Gent model, and the Van der Waals model.

In one embodiment, the reinforcement learning process is partially conducted physically and partially conducted virtually in a virtual environment through simulation. In one embodiment, imitation learning is combined with reinforcement learning to accelerate the learning process. In one embodiment, an initial model or model structure is provided to the learning process as a starting point.

In one embodiment, a model-free approach is adopted for the leaning process. No model or model structure is provided initially to the learning process. Therefore, the learning process also need to learn on its own the physics and constraints of the system.

In one embodiment, one or more of the gripping system controller 105, the gripper controller 340, and the distributed controller 107 select from a group of predefined gripping configurations 500 by methods or models not obtained from machining learning approaches if certain conditions are met, otherwise utilize methods or models obtained from machining learning approaches to determine one or more of the following items including a gripping configuration 500, a pick point 1203, and a pick orientation 1206.

In one embodiment, when the picking system 100 is being used in actual picking operations, data about the gripping process are collected. Such data are used for real-time or offline refinement training of the machining-learning-trained models for determining one or more of the following items including a gripping configuration 500, a pick point 1203, and a pick orientation 1206.

### Gripping Configuration, Pick Pint, Pick Orientation Determination in One Process

In one embodiment, the gripping configuration, the pick point and the pick orientation are all determined in one process as follows: The sensor 103 capture the geometry of the scene containing one or more items 104 to be picked. The captured geometry 1201 is fed to the picking system controller 105. The picking system controller 105 assigns to one or more points in the captured geometry 1201 each with a set of probabilities that can be related to at least one of the following criteria:
Probability of belonging to an item to be picked
Probability of being reachable by the gripper without collision,
Probability of achieving good grasping strength,
Probability of avoiding item damage during picking,
Probability of increasing gripper service life, and
Probability of maximizing speed.

Then, the picking system controller 105 selects one preferable set of probabilities and determines one or more of the following: the pick point can be chosen as the point on the captured geometry corresponding to that set of probabilities; the pick orientation can be found during the calculation of the probability of achieving good grasping strength, the probability of being reachable by the gripper without collision and the probability of maximizing speed; and a gripping configuration can be found during the calculation of the probability of achieving good grasping strength, the probability of avoiding item damage during picking and the probability of increasing gripper service life.

In one embodiment, the gripping configuration, the pick point and the pick orientation are all determined in one process as follows: The sensor 103 capture the geometry of the scene containing one or more items to be picked. The captured geometry 1201 is fed to the picking system controller 105. The picking system controller 105 The picking system controller assigns labels to different regions of the captured geometry 1201, and each label can be related to one of the following affordances:
The affordance of being picked up, i.e. the region is part of an item to be picked up, not a background item such as a part of the bin that holds the item to be picked,
The affordance of being reached by the gripper without collision,
The affordance of being gripped with good grasping strength,
The affordance of being gripped with minimum item damage,
The affordance of being gripped with minimum negative impact on gripper service life, and
The affordance of being gripped with maximum speed.
Labels of different affordances can be overlapping.
Then the picking system controller 105 selects one or more regions in the captured geometry 1201 that are covered by:
At least a label related to the affordance of being picked up,
At least a label related to the affordance of being reached by the gripper without collision,
At least a label related to the affordance of being gripped with good grasping strength, and
The largest number of other labels.
From the selected region do one or more of the following:
Choose a point in the region, possibly randomly, as the pick point,
Identify a pick orientation based on one or more of the calculations done on the region for the affordance of being reached by the gripper without collision, the affordance of being gripped with good grasping strength, the affordance of being gripped with minimum item damage, the affordance of being gripped with minimum negative impact on gripper service life, and the affordance of being gripped with maximum speed.
Determine a gripping configuration based on one or more of the calculations done on the region for the affordance of being gripped with good grasping strength, the affordance of being gripped with minimum item damage, the affordance of being gripped with minimum negative impact on gripper service life, and the affordance of being gripped with maximum speed.

### Drop Prevention

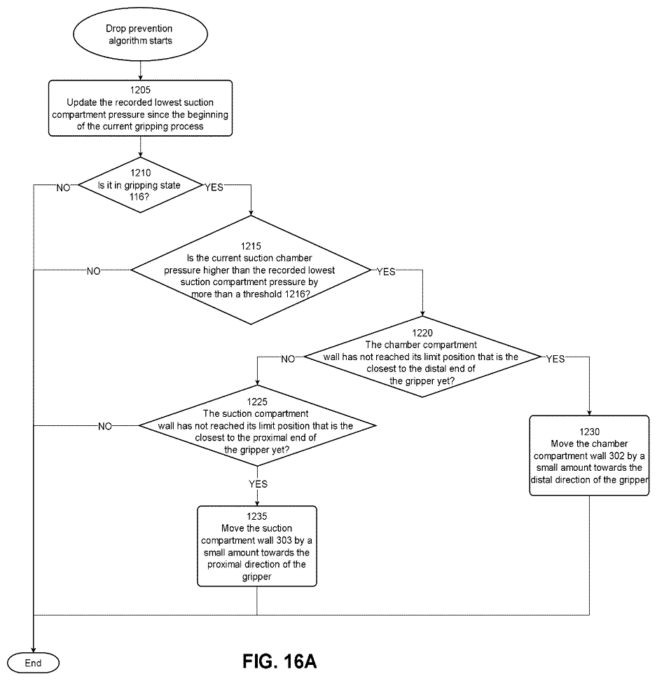

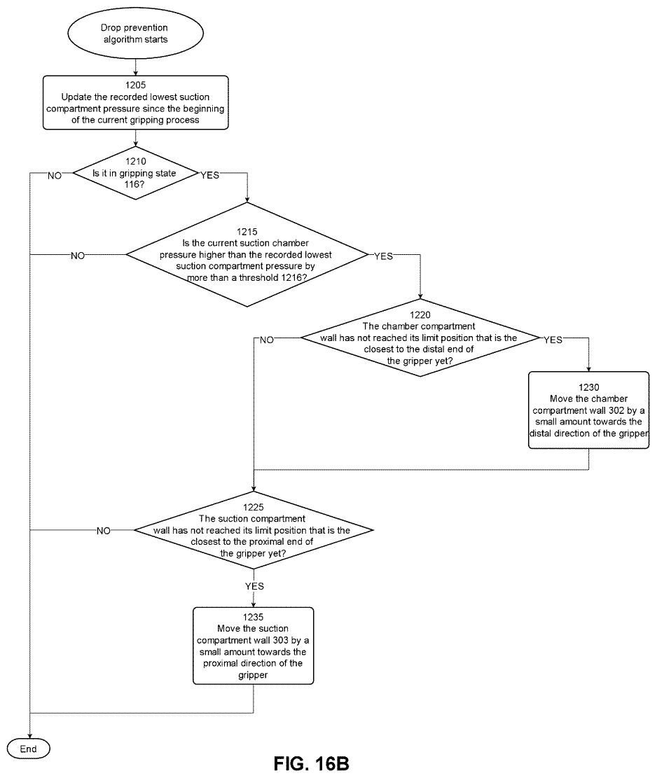

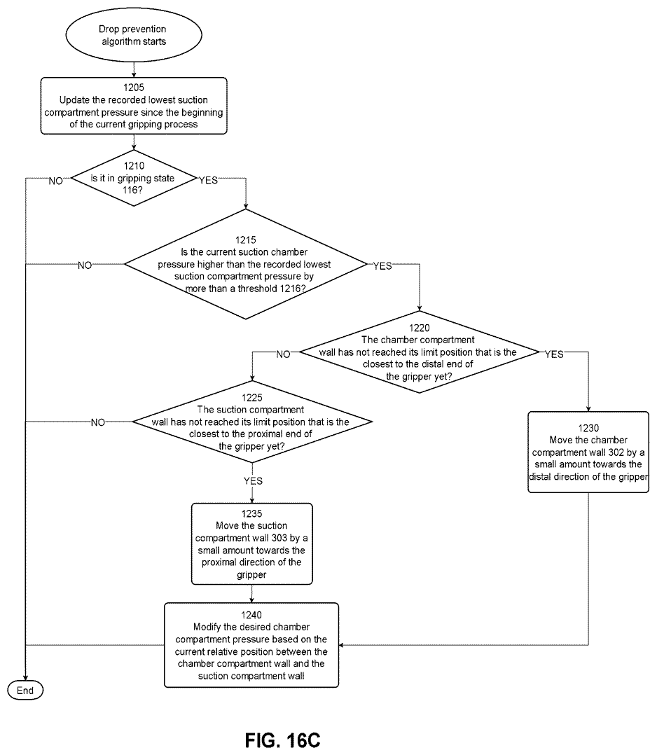

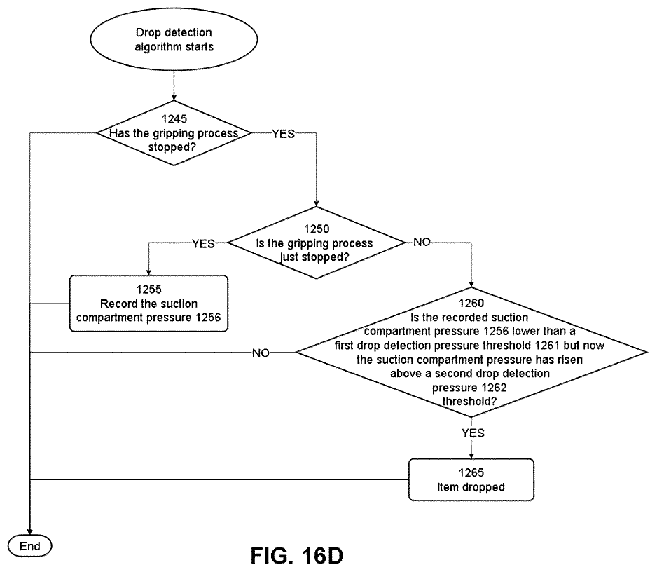

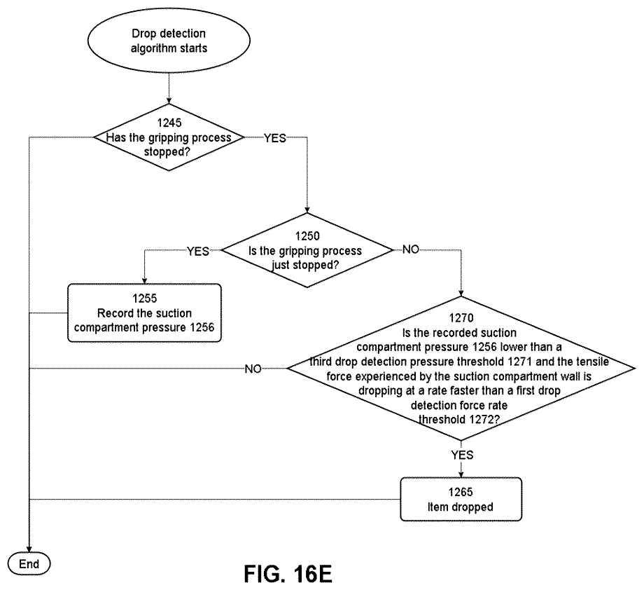

FIGS. 16A to 16E are diagrams illustrating a method for strengthening the grip. In one embodiment, the method as shown in FIG. 16A is executed at fixed or variable intervals during the gripping state 116 and the holding state 117, and it is used to reinforce the grip during the holding state 117 to prevent unintentionally dropping the item 104 being held.

Specifically, during each execution of the method shown in FIG. 16A, the block 1205 records or updates the lowest suction compartment pressure ever detected during the current gripping process. Then after confirming that it is currently in the gripping state 116 through block 1210, the current suction compartment pressure is compared with the lowest suction compartment pressure ever detected during the current gripping process in block 1215. If the current suction compartment pressure is higher than the lowest suction compartment pressure ever detected during the current gripping process by a over a threshold 1216, meaning that the suction on the item might be weakened and as such the grasp on the item 104 may be weakened, blocks 1220, 1225, 1230 and 1235 will be invoked to reinforce the grip. Block 1220 checks if the chamber compartment wall has reached its limit position yet and if not move it towards the distal direction of the gripper by a small amount in the range of 0.01 to 10 mm through block 1230. Otherwise, block 1225 checks if the suction compartment wall has reached its limit position yet and if not move it towards the proximal direction of the gripper by a small amount in the range of 0.01 to 10 mm through block 1235. Through the movement of the chamber compartment wall 302 and the suction compartment wall 303, the center portion of the membrane 301 is progressively drawn more and more to the inside of the chamber compartment wall 302, bring with it the item 104 being held, thus allowing more membrane 301 to envelop the item 104, allowing a better seal to form to reinforce the grip. The range of the small amount movement of the chamber compartment wall and the suction compartment wall is set such that at its lower limit the gripper can still respond fast enough to strengthen the grip without dropping the item, and at its higher limit the gripper is not too fast and pushes the item away 104.

Alternatively, in one embodiment as shown in FIG. 16B, which is a variant of FIG. 16A, both the chamber compartment wall 302 and the suction compartment wall 303 can be moved during a single sampling interval.

In one embodiment as shown in FIG. 16C, which is a variant of FIG. 16A, a block 1240 is added to adjust the desired pressure value in the chamber compartment 304 according to the current relative position between the chamber compartment wall 302 and the suction compartment wall 303. For example, as the chamber compartment wall 302 moves closer to its position limit closest to the distal end of the gripper 101, or as the suction compartment wall 303 moves closer to its position limit closest to the proximal end of the gripper 101, it may be desirable to increase the pressure inside the chamber compartment accordingly so that the membrane 301 can better form around the item 104 being gripped and thus improving gripping reliability. The relationship between the pressure inside the chamber compartment and the chamber compartment wall position, or the suction compartment wall position, or the relative position between them, can be a linear function, a non-linear function, a continuous function, a discontinuous function and a discrete function.

### Drop Detection

### Vacuum Condition Only

In one embodiment, the method as shown in FIG. 16D is executed at fixed or variable intervals during the gripping state 116 and the holding state 117, and it is used to detect unintentionally dropping of items 104.

Specifically, during each execution of the method shown in FIG. 16D, block 1245 checks if the gripping process has stopped. If block 1245 returns false, wait for the next execution of the method. If block 1245 returns true, block 1250 checks if the gripping process has just stopped. If block 1250 returns true, then in block 1255 the suction compartment pressure is recorded as referred to hereafter as the recorded suction compartment pressure when the gripping process stopped 1256. If block 1250 returns false, block 1260 checks if the recorded suction compartment pressure 1256 is lower than a first drop detection pressure threshold 1261 but now the suction compartment pressure has risen above a second drop detection pressure 1262 threshold. If block 1260 returns true, it is considered that the item is dropped as in block 1265.

### Vacuum and Shaft Force Condition

In one embodiment, the method as shown in FIG. 16E is executed at fixed or variable intervals during the gripping state 116 and the holding state 117, and it is used to detect unintentionally dropping of one or more items 104.

Specifically, during each execution of the method shown in FIG. 16E, block 1245 checks if the gripping process has stopped. If block 1245 returns false, wait for the next execution of the method. If block 1245 returns true, block 1250 checks if the gripping process has just stopped. If block 1250 returns true, then in block 1255 the suction compartment pressure is recorded as referred to hereafter as the recorded suction compartment pressure when the gripping process stopped 1256. If block 1250 returns false, block 1270 checks if the recorded suction compartment pressure 1256 is lower than a third drop detection pressure threshold 1271 and the tensile force experienced by the suction compartment wall is dropping at a rate faster than a first drop detection force rate threshold 1272, it is considered that the item is dropped as in block 1265.

In a preferred embodiment, the first drop detection pressure threshold 1261 is set to −35 kPa gauge pressure. The second drop detection pressure threshold 1262 is set to −30 kPa gauge pressure. The third drop detection pressure threshold 1271 is set to −35 kPa gauge pressure. And the first drop detection force rate threshold 1272 is set to −50 N/s. Notice that some of the drop detection thresholds can have the same value.

In one embodiment the method as shown in FIG. 16D and the method as shown in FIG. 16E are run in parallel.

### Membrane Failure Detection

A membrane 301 failure (i.e., occurrence of unintended perforations on the membrane), will have negative impact on the gripping performance of the gripper. Therefore, it is desirable to be able to detect membrane failure so that the damaged membrane can be repaired or replaced.

In one embodiment, membrane 301 failure is detected using the following method: the gripper controller 340 or the picking system controller 105 compare the chamber compartment pressure sensor 331 reading with the chamber compartment pressure set point, which can be defined by the reference chamber compartment pressure profile over time 514. If it is found that the pressure sensor 331 reading is lower than the chamber compartment pressure set point for a least a given period of time, with the difference between them being over a specific percentage of the pressure set point, the membrane is considered failed.

In one embodiment, membrane 301 failure is detected using the following method: Before a gripping operation, record a set of baseline values of control signals applied to, or power consumed by, the chamber compartment pressure mechanism 306 or 308 while it tries to maintain the chamber compartment 304 pressure at or near one or more pressure set points. Then, during the gripping process, monitor at least the control signal applied to, or the power consumed by, the chamber compartment pressure mechanism 306 or 308 and the chamber compartment pressure measured by sensor 331. If the chamber compartment pressure measured by sensor 331 is at or near a pressure set point, and the control signal applied to, or the power consumed by, the chamber compartment pressure mechanism 306 or 308 is higher than the recorded baseline value or the interpolated recorded baseline value corresponding to the pressure set point by over a threshold for a least a given period of time, the membrane 301 is considered failed.

In one embodiment, membrane 301 failure is detected using the following method: the frequency of unintentional dropping of the item is monitored by the gripper controller 340 or the picking system controller 105. If this frequency is over a certain failure criteria threshold, the membrane is considered failed.

### General Gripper Fault Detection

### General Fault Detection Algorithm

In one embodiment, faults of the gripper, including but not limited to one or more of the following: membrane failure, mechanical component failure, actuator failure, pressure mechanism failure, sensor failure, controller failure, and collision between the gripper and one or more items outside of the gripper, are detected by using one or more fault detection algorithms including isolation forest, one class support vector machine, and Mahalanobis distance. Specifically, during a picking operation, the control signals to one or more actuators and the control signals to one or more pressure mechanisms and the sensor signals are fed to the fault detection algorithm. Then, when the fault detection algorithm detects outliners in the control signals and/or sensor signals, one or more of the aforementioned faults are considered to have occurred.

### Model-Based

In one embodiment, faults of the gripper, including but not limited to one or more of the following: membrane failure, mechanical component failure, actuator failure, pressure mechanism failure, sensor failure, controller failure, and collision between the gripper and one or more items outside of the gripper, are detected by using a model-based fault detection method as follows: A model is developed for simulating the physical operation of the gripper. During a picking operation, the control signals to one or more actuators and the control signals to one or more pressure mechanisms are fed to the model to generate one or more predicted sensor signals. Then, the predicted sensor signals are compared with the actual sensor readings. If the deviations between one or more actual sensor readings and one or more predicted sensor readings are over one or more thresholds, one or more of the aforementioned faults are considered to have occurred.

### Signal Processing Based-Processing Sensor Signals

In one embodiment, faults of the gripper, including but not limited to one or more of the following: membrane failure, mechanical component failure, actuator failure, pressure mechanism failure, sensor failure, controller failure, and collision between the gripper and one or more items outside of the gripper, are detected by using a signal-processing-based fault detection method as follows: before a picking operation starts, fault-indicating characteristics of the sensor readings regarding the occurrence of one or more of the following faults are established: membrane failure, mechanical component failure, actuator failure, pressure mechanism failure, sensor failure, controller failure, and collision between the gripper and one or more items outside of the gripper. Then during a picking operation, the one or more sensor signals are monitored by the gripper controller 340 or the picking system controller 105. From the sensor signals, if the controller identifies characteristics matching one or more of the fault-indicating characteristics, it is considered that the corresponding one or more faults have occurred.

### Signal Processing Based-Processing Actuator Control Signals

In one embodiment, faults of the gripper, including but not limited to one or more of the following: membrane failure, mechanical component failure, actuator failure, pressure mechanism failure, sensor failure, controller failure, and collision between the gripper and one or more items outside of the gripper, are detected by using a signal-processing-based fault detection method as follows: before a picking operation starts, fault-indicating characteristics of the control signals applied to one or more actuators and one or more pressure mechanisms regarding the occurrence of one or more of the following faults are established: membrane failure, mechanical component failure, actuator failure, pressure mechanism failure, sensor failure, controller failure, and collision between the gripper and one or more items outside of the gripper. Then during a picking operation, the control signals applied to one or more actuators and one or more pressure mechanisms are monitored by the gripper controller 340 or the picking system controller 105. From the control signals, if the controller identifies characteristics matching one or more of the fault-indicating characteristics, it is considered that the corresponding one or more faults have occurred.

### Methods for Stopping the Robot Once the Gripper is in Contact With the Item

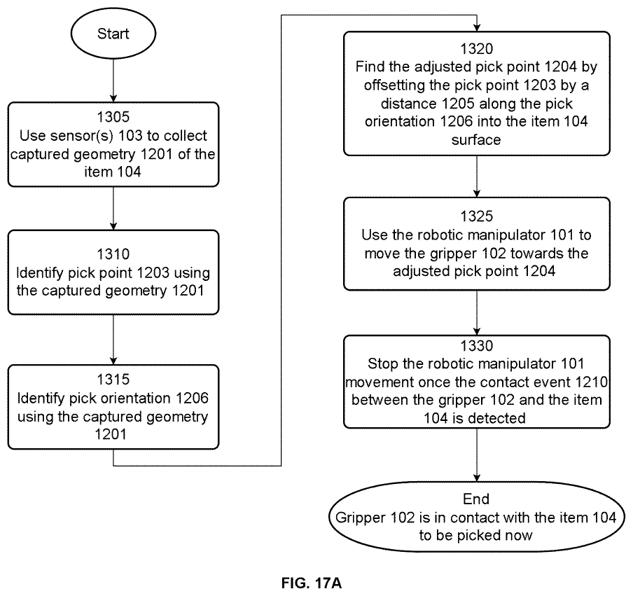

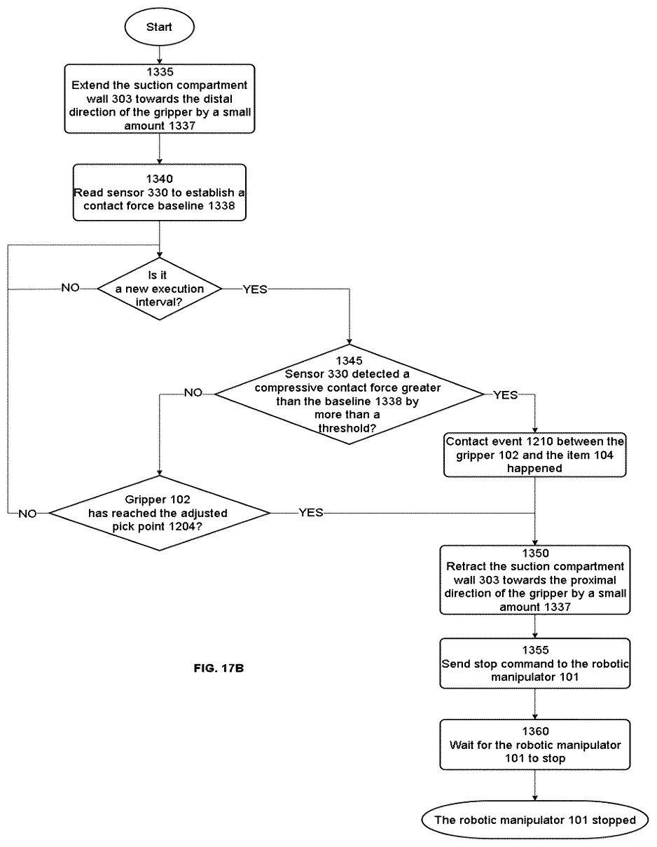

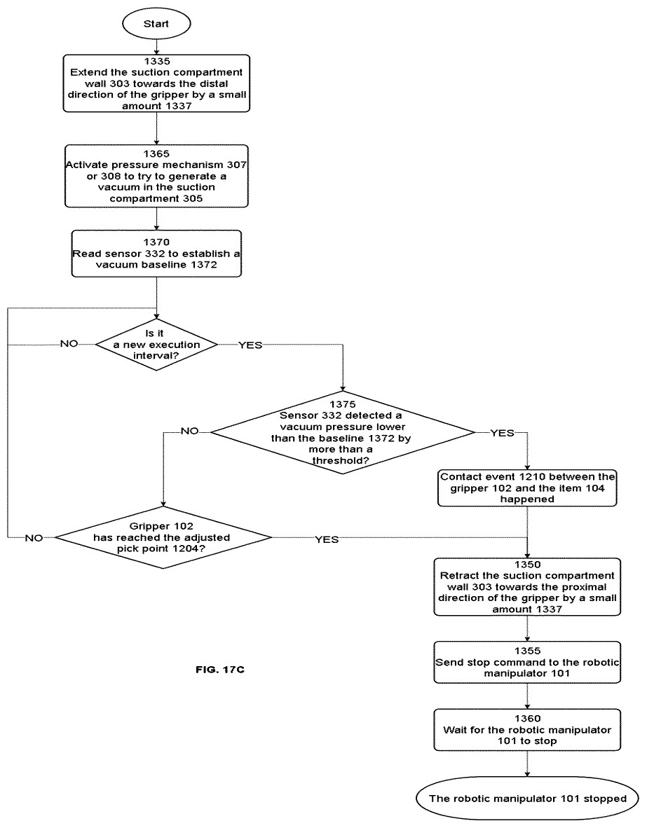

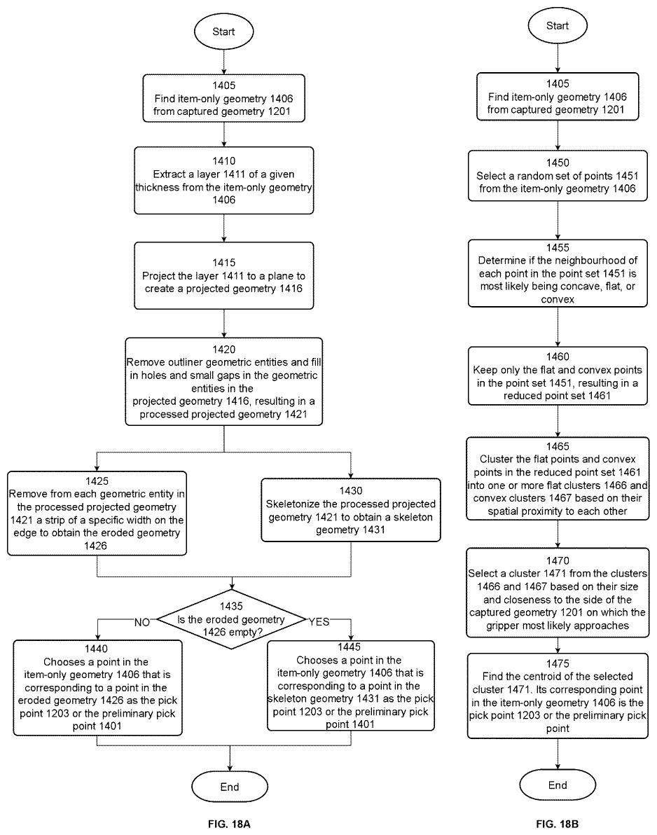

In one embodiment, the sensor(s) 103 may comprise one or more image sensors that capture the geometry 605 of the surface of the item 104 or a portion of the surface of the item 104 to be picked. The captured geometry 1201 may be different from the actual geometry 605 due to sensor error. As a result, if a pick point 1203 is subsequently identified on the captured geometry 1201, the identified pick point 1203 may not be exactly on the item 104 surface, or exactly on the actual geometry 605. In fact, it is most likely inside the item 104 or at a small distance from the item 104 surface due to image sensor error. In this case if the robotic manipulator 101 is commanded to move the gripper 102 to this identified pick point 1203 to pick the item 104, the gripper 102 will most likely crush into the item 104 or trying to pick a point in the air, resulting in failed picks. Therefore, special method of manipulating the gripper 102 is needed to compensate for the image sensor error to allow the gripper 102 to grip properly. FIGS. 17A to 17C are diagrams illustrating a method for stopping the robotic manipulator once the gripper is in contact with the item to be picked.

### Robot Stopping by Load Cell

In one embodiment, the method of manipulating the gripper as shown in FIG. 17A is to command the robotic manipulator 101 to move the gripper 102 to an adjusted pick point 1204 that is offset from the identified pick point 1203 by a distance 1205 along the pick orientation 1206 so that the adjusted pick point 1204 is beneath the item 104 surface or beneath the actual geometry 605 to ensure contact between the gripper 102 and the item 104. Then use one or more sensors 103, 330, 331, 332, 333, 334, 335, etc., to detect the event of contact 1210 between the gripper 102 and the item 104 and stop the robotic manipulator 101 movement once such event of contact 1210 is detected to prevent the gripper 102 from crushing into the item 104.

A more detailed embodiment of the block 1330 for detecting the event of contact 1210 and then stopping the robotic manipulator 101 is present in FIG. 17B. Specifically, at the beginning before the gripper 102 contacts the item 104, In block 1335 the suction compartment wall 303 is extended towards the distal direction of the gripper 102 by a small amount 1337. The amount 1337 is preferably to be sufficiently large to accommodate the distance needed for the robotic manipulator 101 to decelerate. Then in block 1340 the sensor 330 reading is recorded to establish a contact force baseline 1338. Then during each sampling: block 1345 checks if the sensor 330 detects a compression force that is greater than the baseline 1338 by a predefined threshold. If block 1345 returns true, it means the event of contact 1210 happened and blocks 1350, 1355, and 1360 are executed. Specifically in block 1350 the suction compartment wall 303 is retracted towards the proximal direction of the gripper 102 by a small amount 1337. This is for allowing more distance for the robotic manipulator 101to decelerate to prevent the gripper 102 from crushing into the item 104. Then in block 1355 a stop command is sent to the robotic manipulator 101. Block 1360 waits for the robotic manipulator 101 to stop. If block 1345 remains false but the gripper 102 has reached the adjusted pick point 1204, blocks 1350, 1355, and 1360 are also executed. This usually the case if the item 104 is very soft and therefore the compressive force exerted on the suction compartment wall 303 remains very small as the gripper 102 pushes into the item 104.

### Robot Stopping by Vacuum

Another more detailed embodiment of the block 1330 for detecting the event of contact 1210 and then stopping the robotic manipulator 101 is present in FIG. 17C. Specifically, at the beginning before the gripper 102 contacts the item 104, In block 1335 the suction compartment wall 303 is extended towards the distal direction of the gripper 102 by a small amount 1337. Then in block 1365 the pressure mechanism 307 or 308 are activated to try to generate a vacuum in the suction compartment 305. Then in block 1370 the sensor 332 reading is recorded to establish a vacuum baseline 1372. Then during each sampling: block 1375 checks if the sensor 332 detects a vacuum pressure that is lower than the baseline 1372 by a predefined threshold. If block 1375 returns true, it indicates that the suction compartment opening 321 is a least partially block by the item 104 such that a strong enough vacuum is established inside the suction compartment 305, and the event of contact 1210 happened, and blocks 1350, 1355, and 1360 are then executed. Specifically in block 1350 the suction compartment wall 303 is retracted towards the proximal direction of the gripper 102 by a small amount 1337. This is for allowing more distance for the robotic manipulator 101 to decelerate to prevent the gripper 102 from crushing into the item 104. Then in block 1355 a stop command is sent to the robotic manipulator 101. Block 1360 waits for the robotic manipulator 101 to stop. If block 1345 remains false but the gripper 102 has reached the adjusted pick point 1204, blocks 1350, 1355, and 1360 are also executed. This usually the case if the item 104 is very leaky, e.g. a mesh bag, and therefore the vacuum inside the suction compartment 305 remains very weak as the gripper 102 pushes into the item 104.

### Robot Stopping by Load Cell and Vacuum

In another more detailed embodiment of the block 1330 for detecting the event of contact 1210 and then stopping the robotic manipulator 101, the method in FIG. 17B and the method in FIG. 17C are run in parallel to use both the contact force detected by the sensor 330 and the vacuum pressure in the suction compartment detected by the sensor 332 to detect the event of contact 1210 more reliably.

### Pick Point Determination

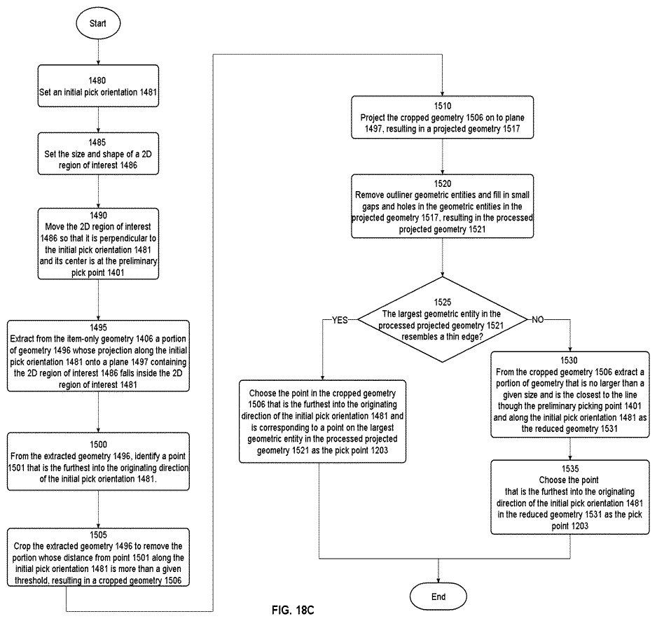

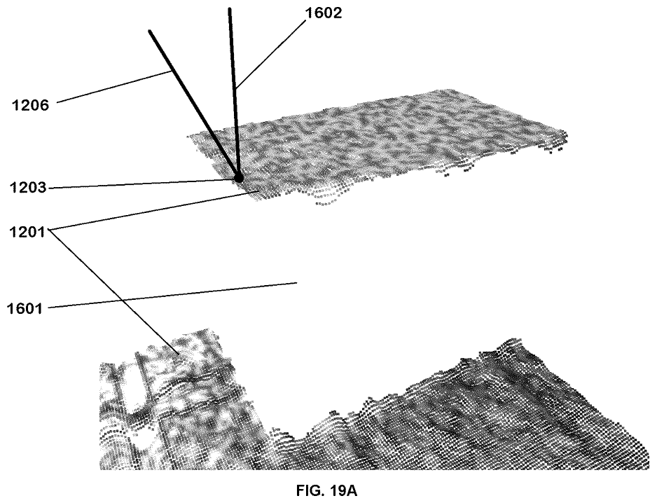

FIGS. 18A to 18C are diagrams illustrating a method for determining a pick point in the preferred embodiment. Specifically, the method for identifying a pick point 1203 from the captured geometry 1201, which is also an embodiment of the block 1310, is divided into two stages.

The first stage identifies a preliminary pick point 1401 without concerning too much detail about local features in the captured geometry 1201 around the preliminary pick point 1401. The process of this first stage is shown in FIG. 18A and FIG. 18B. Since the first stage does not consider too much detail about the local geometry, the preliminary pick point 1401 may not be easily pickable but should be close to one or more easily pickable points. The second stage, as shown in FIG. 18C, adjusts the preliminary pick point 1401 by considering the local geometric features in the captured geometry 1201, resulting in the pick point 1203.

One embodiment of the first stage is shown in FIG. 18A. It tries to select a preliminary pick point 1401 that is close to the portion of the captured geometry 1201 that is both (a) the closest to the originating direction along which the gripper is most likely to approach and (b) far away from the edge of the item 104, to increase the chance of a good grip.

At the start, the captured geometry 1201 may contain geometric features not belonging to the item(s) 104 to be picked. Such geometric features are removed in block 1405 to obtain the item-only geometry 1406. This can be done by, for example, thresholding.

Then, in block 1410, extract a layer 1411 of a given thickness from the item-only geometry 1406. The value for the given thickness is chosen such that the extracted geometry 1411 covers a depth range large enough to keep the small irregularities of the item(s) 104 surface near the top, but small enough to not include the portion of the item(s) 104 surface that is too far away from the top and there for not easily accessible by the gripper 102 due possible occlusion and collision. The layer 1411 is extracted in a way such that the two planes that delimit the layer 1411 are perpendicular to the direction along which the gripper most likely approaches. One of the said planes touches the extracted geometry 1411, and no part of the item-only geometry 1406 is on the side of the plane in which the gripper 102 may approach.

In block 1415, the layer of geometry 1411 is projected to a plane parallel to the delimiting planes of the layer of geometry 1411 to create a projected geometry 1416. Then, in block 1420, Operations are done on the projected geometry 1416 to eliminate outliner geometric entities and fill in holes and small gaps in the remaining geometric entities, resulting in a processed projected geometry 1421.

Then, in block 1425, a strip of a specific width on the edge of each geometric entities in the processed projected geometry 1421 is removed. The width of the strip is preferably chosen to be slightly larger than the radius of the gripper. The pick point may be chosen in latter steps from the remaining geometric entities in the resulting eroded geometry 1426. The purpose of this edge strip removal operation is to prevent choosing a preliminary pick point 1401 or a pick point 1203 too close to the edge of an item 104. But if the item 104 is too small there is a possibility that the operation in block 1425 will completely remove all geometric entities in the processed projected geometry 1421, i.e. without any geometric entities left from which to choose the preliminary pick point 1401 or the pick point 1203 from. To solve this, in block 1430, the processed projected geometry 1421 is skeletonized to obtain a skeleton projected geometry 1431.

Then, block 1435 checks if the eroded geometry 1426 is empty. If false, block 1440 chooses a point in the item-only geometry 1406 that is corresponding to a point in the eroded geometry 1426 as the pick point 1203 or the preliminary pick point 1401, preferably randomly. If the eroded geometry 1426 is empty, block 1445 chooses a point in the item-only geometry 1406 that is corresponding to a point in the skeleton geometry 1431 as the pick point 1203 or the preliminary pick point 1401, preferably randomly.

Another embodiment of the first stage is shown in FIG. 18B. It tries to select a preliminary pick point 1401 or a pick point 1203 in the most pronounced convex or flat region in the capture geometry to increase the chance of a good grip.

At the start, the captured geometry 1201 may contain geometric features not belonging to the item(s) 104 to be picked. Such features are removed in block 1405 to obtain the item-only geometry 1406. This can be done by, for example, thresholding.

Then, in block 1450, a random set of points 1451 are selected from the item-only geometry 1406 for reducing the subsequent computational load. Then, in block 1455, for each point in the point set 1451, determine whether its neighbourhood is most likely being concave, flat, or convex. Preferably the size of the neighbourhood is chosen to be close to the diameter of the gripper.

Then, in block 1460, keep only the points that are most likely to be flat or convex in the point set 1451, resulting in a reduced point set 1461. Then, in block 1465, cluster the points in the reduced point set 1461 that are most likely flat into one or more flat clusters 1466 based on their spatial proximity to each other, and cluster the points in the reduced point set 1461 that are most likely convex into one or more convex clusters 1467 based on their spatial proximity to each other.

Then, in block 1470, select a cluster 1471 from the clusters 1466 and 1467 based on their size and closeness to the top of the captured geometry 1201. Preferably, the selection criteria can be a weighted score between the cluster size and the closeness to the side of the captured geometry 1201 on which the gripper most likely approaches.

Finally, in block 1475, the point in the item-only geometry 1406 corresponding to the centroid of the selected cluster 1471 is selected as the preliminary pick point 1401.

One embodiment of the second stage is shown in FIG. 18C. It adjusts the preliminary pick point 1401 locally considering the detailed local geometry so that the resulting pick point 1203 is a more easily pickable point. For example, if a preliminary pick point 1401 is set to a point slightly on the inside wall of a cup, which is difficult to be approached and gripped by the gripper 102, the second stage can adjust the preliminary pick point 1401 to a point on top of the rim of the cup as the pick point 1203 that is the closest to the preliminary pick point 1401 to ensure a grip is possible.

At the start, block 1480 set an initial pick orientation 1481. In the preferred embodiment, the initial pick orientation 1481 is set to be pointing down vertically. Then, in block 1485 set the size and shape of a 2D region of interest 1486. In the preferred embodiment, the 2D region of interest 1486 is set to a circle with diameter equal to that of the gripper 102, or an octangle with distances between opposing edges equal to that of the gripper 102 for reducing computational cost.

Then, in block 1490, the center of the 2D region of interest 1486 is located at the preliminary pick point 1401 and the 2D region of interest 1486 is oriented such that it is perpendicular to the initial pick orientation 1481.

Then, in block 1495, extract from the item-only geometry 1406 a portion of geometry 1496 whose projection along the initial pick orientation 1481 onto a plane 1497 containing the 2D region of interest 1486 falls inside the 2D region of interest 1481.

Then, in block 1500, from the extracted geometry 1496, identify a point 1501 that is the furthest away from the plane 1497 and on the side of the said plane 1497 from which the gripper 102 can approach.

Then, in block 1505, crop the extracted geometry 1496 to remove the portion whose distance from point 1501 along the initial pick orientation 1481 is more than a given threshold, resulting in a cropped geometry 1506. The threshold is preferably set to around 25 millimetres.

Then, in block 1510, project the cropped geometry 1506 on to plane 1497, resulting in the projected geometry 1517. Then, in block 1520, operations are applied to the projected geometry 1517 to remove outliner geometric entities and fill in small gaps and holes in the geometric entities, resulting in the processed projected geometry 1521.

Then, in block 1525, check if the shape of the largest geometric entity in the processed projected geometry 1521 resembles a thin edge. If true, choose the point in the cropped geometry 1506 that is the furthest into the originating direction of the initial pick orientation 1481 and is corresponding to a point on the largest geometric entity in the processed projected geometry 1521 as the pick point 1203. If false, go on to block 1530.

Then, in block 1530, from the cropped geometry 1506 extract a portion of geometry that is no larger than a given size and is the closest to the line though the preliminary picking point 1401 and along the initial pick orientation 1481 as the reduced geometry 1531. In the preferred embodiment, the cropped geometry 1506 is a point cloud and the given size is set to 250 points.

Then, in block 1535, the is the furthest into the originating direction of the initial pick orientation 1481 in in the reduced geometry 1531 is chosen as the pick point 1203.

It should be noted that any one of the said two stages can be applied to the captured geometry 1201 independently and individually without the use of the other. And the output of either stage can be used as the pick point 1203. When only the first stage is used, the preliminary pick point 1401 becomes the pick point 1203. When only the second stage is used, the preliminary pick point 1401 can be supplied by for example a randomly selected point in the captured geometry 1201, by operator input, by a different algorithm, etc.

### Pick Orientation Determination Around Edges and Corners

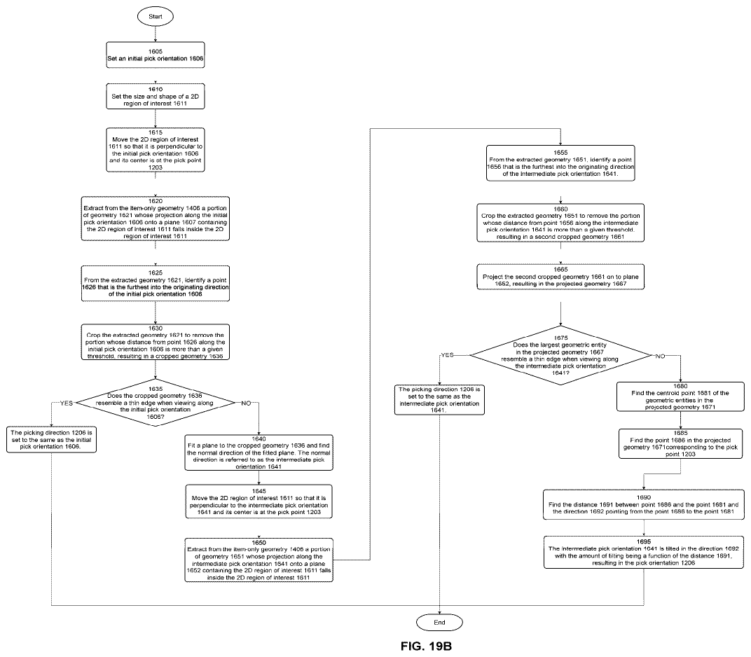

FIG. 19A is a diagram illustrating the problem of determining a pick orientation from a point cloud with holes. FIG. 19B is a diagram illustrating a method for determining a pick orientation. In the preferred embodiment, a method for identifying a preferred pick orientation 1206 given the captured geometry 1201 and the pick point 1203, or an embodiment of the block 1315, is described in the following. The motivation behind this method is that the captured geometry 1201 is usually not a complete representation of the actual geometry 605 of the item(s) 104. Instead, due to factors such as occlusion and limited angle of view of the image sensor 103, there will be holes in the captured geometry, or regions without geometric information 1601. If the actual pick point 1203 is in or near such a region, simple methods such as fitting a plane to the part of the captured geometry 1201 that is in the neighbourhood of the pick point 1203 and then finding its normal may yield an unsatisfactory pick orientation 1602 compared to the preferred pick orientation 1206, as shown in FIG. 19A. Therefore, special methods need to be used to handle such cases and one embodiment of such methods is shown in FIG. 19B.

At the start, block 1605 set an initial pick orientation 1606. In the preferred embodiment, the initial pick orientation 1481 is set to be pointing down vertically. Then, in block 1610 set the size and shape of a 2D region of interest 1611. In the preferred embodiment, the 2D region of interest 1611 is set to a circle with diameter equal to that of the gripper 102, or an octangle with distances between opposing edges equal to that of the gripper 102 for reducing computational cost.

Then, in block 1615, the center of the 2D region of interest 1611 is located at the pick point 1203 and the 2D region of interest 1611 is oriented such that it is perpendicular to the initial pick orientation 1606. Then, in block 1620, extract from the item-only geometry 1406 a portion of geometry 1621 whose projection along the initial pick orientation 1606 onto a plane 1607 containing the 2D region of interest 1611 falls inside the 2D region of interest 1611.

Then, in block 1625, from the extracted geometry 1621, identify a point 1626 that is the furthest into the originating direction of the initial pick orientation 1606. Then, in block 1630, crop the extracted geometry 1621 to remove the portion whose distance from point 1626 along the initial pick orientation 1606 is more than a given first distance-from-the-top threshold, resulting in a cropped geometry 1636. The given first distance-from-the-top threshold is preferably set to around 40 millimetres.

Then, in block 1635, check if viewing from the initial pick orientation 1606 the cropped geometry 1636 is a thin edge. If true, the picking direction 1206 is set to the same as the initial pick orientation 1606. Otherwise, go on to run block 1640. Then, in block 1640, fit a plane to the cropped geometry 1636 and find the normal direction of the fitted plane. The normal direction is referred to as the intermediate pick orientation 1641.

Then, in block 1645, the center of the 2D region of interest 1611 is located at the pick point 1203 and the 2D region of interest 1611 is oriented such that it is perpendicular to the intermediate pick orientation 1641. Then, in block 1650, extract from the item-only geometry 1406 a portion of geometry 1651 whose projection along the intermediate pick orientation 1641 onto a plane 1652 containing the 2D region of interest 1611 falls inside the 2D region of interest 1611.

Then, in block 1655, from the extracted geometry 1651, identify a point 1656 that is the furthest into the originating direction of the intermediate pick orientation 1641. Then, in block 1660, crop the extracted geometry 1651 to remove the portion whose distance from point 1656 along the intermediate pick orientation 1641 is more than a given second distance-from-the-top threshold, resulting in a second cropped geometry 1661. The given second distance-from-the-top threshold is preferably set to around 25 millimetres.

Then, in block 1665, project the second cropped geometry 1661 on to plane 1652, resulting in the projected geometry 1671. Then, in block 1675, check if the largest geometric entity in the projected geometry 1671 is a thin edge. If true, the picking direction 1206 is set to the same as the intermediate pick orientation 1641. Otherwise, go on to run block 1680.

Then, in block 1680, the centroid point 1681 of all geometric entities projected geometry 1671 is found. Then, in block 1685, the point 1686 in the projected geometry 1671 corresponding to the pick point 1203 is found. Then, in block 1690, the distance 1691 between point 1686 and the point 1681 and the direction 1692 pointing from the point 1686 to the point 1681 is found.

Then, in block 1695, the intermediate pick orientation 1641 is adjusted as follows to obtain the preferred pick orientation 1206: the intermediate pick orientation 1641 is tilted in the direction 1692 with the amount of tilting being a function of the distance 1691. In the preferred embodiment this function is a linear function with the tilting amount in radian being the distance 1691 in millimetre times 1.5 radian per millimetre.

According to the disclosure, a gripper system is disclosed. The gripper system comprises a chamber compartment delimited by at least a chamber compartment wall and a deformable membrane attached to at least the chamber compartment wall, a suction compartment delimited by the suction compartment wall, at least one pressure mechanism for modulating the pressure in the chamber compartment and the pressure in the suction compartment, at least one actuator for modulating the position of the chamber compartment wall or the position of the suction compartment wall, at least one on-gripper sensor and at least one controller.

According to the disclosure, a method of gripping an item, using a gripper system is disclosed. The method comprising the steps of controlling the chamber compartment wall position over time if the chamber compartment wall is not fixed to the gripper, controlling the suction compartment wall position over time if the suction compartment wall is not fixed to the gripper, controlling the chamber compartment pressure over time and controlling the suction compartment pressure over time. The on-gripper sensor is selected from a list consisting of position, force, and pressure sensors.

According to the disclosure, the method further comprising the execution of one or more of the following functions during a gripping process including information provided by the on-gripper sensor is processed by a controller to help control the gripper operation during the gripping process, information provided by the on-gripper sensor is processed by a controller to estimate the strength of the grip, the controller generates a control command to adjust the control parameters to modulate the strength of the grip and information provided by the on-gripper sensor is processed by a controller to detect the unintentional dropping of one or more items.

According to the disclosure, the algorithm for detecting failures is selected from a list consisting of isolation forest, one class support vector machine and mahalanobis distance. The algorithm is used for detecting one or more failures wherein the failure is selected from a list consisting of membrane failure, mechanical component failure, actuator failure, pressure mechanism failure, sensor failure, controller failure, collision between the gripper and one or more items outside of the gripper. The failure is detected from one or more control signals applied to one or more actuators, from one or more control signals applied to one or more pressure mechanisms or from one or more on-gripper sensor signals.

According to the disclosure, the method during a gripping process, one or more of the chamber compartment wall position, the suction compartment wall position, the chamber compartment pressure, and the suction compartment pressure, are controlled according to a gripping configuration that defines a set of process parameters of the gripping process. The set of process parameters is selected from a list consisting of position, velocity, acceleration, pressure, current, voltage, force, power, and electrostatic force.

According to the disclosure, the configuration comprises a set of process parameters selected from a list consisting of a profile of the chamber compartment wall position over time during the gripping process if the chamber compartment wall is not fixed relative to the gripper, a profile of the suction compartment wall position over time during the gripping process if the suction compartment wall is not fixed relative to the gripper, a profile of the chamber compartment pressure over time during the gripping process, and a profile of the suction compartment pressure over time during the gripping process.

According to the disclosure, the gripping configuration further comprises a set of parameters used in the said process logic, a process logic that determines at least a portion of the execution of the profiles comprising the steps of starting the gripping process following a gripping configuration comprising a number of position profiles and pressure profiles over time, obtaining information through the on-gripper sensors regarding one or more of the following values continuously, the suction compartment wall position, the chamber compartment wall position, the chamber compartment pressure, and the suction compartment pressure, feeding the information obtained in the previous step to the process logic continuously, determining when, how, or whether to modify the gripping configuration currently being followed and determining when, how, or whether to stop the execution of the gripping process.

According to the disclosure, a method to determine the gripping configuration, using a gripper system is disclosed. The method comprising the steps of using one or more image sensors to capture the geometry of a region of interest around a given pick point and along the given pick orientation on the one or more items to be picked and feeding the captured geometry to one or more picking system controllers or the controller of the gripper to determine a gripping configuration.

According to the disclosure, the gripping configuration is selected from a list consisting of a chamber compartment wall position profile over time during the gripping process, a suction compartment wall position profile over time during the gripping process, a chamber compartment pressure profile over time during the gripping process, a suction compartment pressure profile over time during the gripping process, a process logic that determines if, how, and when to modify or stop the execution of the gripping process, and a set of parameters used in the said process logic.

According to the disclosure, the picking system controller or the gripper controller further comprises the steps of extracting information from the captured geometry of the region of interest about the material of the item in the region of interest to be picked, finding the best fit between the material information of the item to be pick in the region of interest and a set of pre-defined material models and determining at least a part of the gripping configuration from the best fitted material model.

According to the disclosure, the picking system controller or the gripper controller generates one or more of gripping configuration, pick point, or pick orientation by one or more models which is at least partially obtained by imitation learning. The picking system controllers or the gripper controller generates one or more of gripping configuration, pick point or pick orientation by one or more models which is at least partially obtained by reinforcement learning.

According to the disclosure, a system to determine a pick point, pick orientation, or gripping configuration for a picking system. The system comprises a gripper, a robotic manipulator to which a gripper is attached, at least one image sensor and at least one controller.

According to the disclosure, method to determine a pick point, pick orientation, and gripping configuration comprises the steps using one or more image sensors to capture the geometry of the scene containing one or more items to be picked, feeding the captured geometry to the picking system controller, assigning to one or more points in the captured geometry each with a set of probabilities, selecting one preferable set of probabilities by the picking system, from the preferable set of probabilities and the corresponding point on the captured geometry determining one or more of a pick point, a pick orientation and a gripping configuration.

According to the disclosure, the set of probabilities is selected from a list consisting of probability of achieving good grasping strength, probability of avoiding item damage during picking, probability of increasing gripper service life, probability of maximizing speed, probability of belonging to an item to be picked and probability of being reachable by the gripper without collision.

According to the disclosure, a method to determine a pick point, pick orientation, and gripping configuration for a picking system comprising the steps of using one or more image sensors to capture the geometry of the scene containing one or more items to be picked, feeding the captured geometry to the picking system controller, using the picking system controller to assign labels to different regions of the captured geometry, and each label can be related to one or more affordances, selecting one or more regions by the picking system controlled in the captured geometry and from the selected region do one or more of the following choosing a point as the pick point, identifying a pick orientation and determining a gripping configuration.

According to the disclosure, the one or more affordances is selected from a list consisting of affordance of being picked up, (i.e. the labeled region is on an item to be picked instead of on the bin or table top), affordance of being reached by the gripper without collision, affordance of being gripped with good grasping strength, affordance of being gripped with minimum item damage, affordance of being gripped with minimum negative impact on gripper service life, and affordance of being gripped with maximum speed. The labels of different affordances can be overlapping. The selected one or more regions in the captured geometry that are covered by at least a label related to the affordance of being picked up, at least a label related to the affordance of being reached by the gripper without collision, at least a label related to the affordance of being gripped with good grasping strength, and the largest number of other labels.

According to the disclosure, a system to determine the gripping configuration for a gripper is disclosed. The system comprising a chamber compartment delimited by at least a chamber compartment wall and a deformable membrane attached to at least the chamber compartment wall, a suction compartment delimited by the suction compartment wall, at least one pressure mechanism for modulating the pressure in the chamber compartment and the pressure in the suction compartment, at least one actuator for modulating the position of the chamber compartment wall and the position of the suction compartment wall, on-gripper sensors for measuring chamber compartment wall position, suction compartment wall position, force experienced by the suction compartment wall, chamber compartment pressure, and suction compartment pressure, and at least a controller.

According to the disclosure, a method of determining the gripping configuration, using a system, the method comprising the steps of starting the gripping process following a given default gripping configuration comprising a chamber compartment position profile over time, a suction compartment position profile over time, chamber compartment pressure profile over time, and a suction compartment position profile over time, monitoring the on-gripper sensors readings before the chamber position reaches a given threshold, collecting data, once the chamber position reaches the given threshold, feeding the collected data to the controller to determine a gripping configuration.

According to the disclosure, the step of collecting data further comprises collecting the maximum chamber compartment pressure reading between the time when the gripping process starts and the time when the chamber compartment wall position reaches the given threshold, the force experienced by the suction compartment wall when the chamber position reaches the given threshold, the chamber compartment pressure when the chamber compartment wall position reaches the given threshold and the suction compartment pressure when the suction compartment wall position reaches the given threshold.

According to the disclosure, the method of determining the gripping configuration, using a system, the method comprising the steps of starting the gripping process following a given default gripping configuration comprising a chamber compartment position profile over time, a suction compartment position profile over time, chamber compartment pressure profile over time, and a suction compartment position profile over time, monitoring the on-gripper sensors readings before the chamber position reaches a given threshold and collect data continuously or at intervals, once the chamber position reaches the given threshold, feeding the collected data to the controller to determine a gripping configuration.

According to the disclosure, the step of collecting data further comprises collecting the profile of the chamber compartment pressure, the profile of the suction compartment pressure; and the profile of the force experienced by the suction compartment wall.

According to the disclosure, the method of determining the gripping configuration further comprises determining a chamber compartment wall position profile over time during the gripping process, a suction compartment wall position profile over time during the gripping process, a chamber compartment pressure profile over time during the gripping process, a suction compartment pressure profile over time during the gripping process, a process logic that determines if, how, and when to modify or stop the execution of the gripping process, and a set of parameters used in the said process logic.

According to the disclosure, the process logic and the process logic parameters are combined to use as a method for determining the gripping configuration comprising the steps of starting the gripping process following an initial gripping configuration comprising a number of position profiles and pressure profiles over time, obtaining information through the on-gripper sensors regarding one or more of the following values continuously: the suction compartment wall position, the chamber compartment wall position, the chamber compartment pressure, and the suction compartment pressure, feeding the information obtained in the previous step to the process logic continuously or at intervals, determining when, how, or whether to modify the gripping configuration currently being followed, effectively resulting in a gripping configuration different from the initial gripping configuration, and determining when, how, or whether to stop the execution of the gripping process, effectively resulting in a gripping configuration different from the initial gripping configuration.

According to the disclosure, the system further comprising a robotic manipulator to which the gripper is attached, at least one geometry capturing sensor mounted on the gripper or the robotic manipulator and at least one picking system controller, which can be integrated with the controller for the gripper as one integrated controller or can comprise one or more separate controllers.

According to the disclosure, a method of determining the gripping configuration, using a system. The gripping configuration comprises the steps of before the gripper contacts the item to be picked, execute the following steps repeatedly at fixed or variable intervals, using the geometry capturing sensor to capture the geometry of the whole or a part of the item to be picked, feeding the geometry captured is to the picking system controller (the capture geometry is getting progressively more detailed as the sensor getting closer and closer to the item due to robot movement), generating a gripping configuration using the picking system controller with one or more items, after the gripper contacts the item to be picked, initiating the gripping process following the picking configuration generated before the gripper contacts the item to be picked, then do the following steps repeatedly continuously or at fixed or variable intervals during the gripping process, obtaining information through the on-gripper sensors regarding one or more of the following values continuously or at intervals: the suction compartment wall position, the chamber compartment wall position, the chamber compartment pressure, and the suction compartment pressure, feeding the information obtained in the previous step to the process logic continuously or at intervals, determining when, how, or whether to modify the gripping configuration currently being followed, determining when, how, or whether to stop the execution of the gripping process.

According to the disclosure, the method wherein the one or more items of the gripping configuration is selected from a list consisting of a chamber compartment wall position profile over time during the gripping process, a suction compartment wall position profile over time during the gripping process, a chamber compartment pressure profile over time during the gripping process, a suction compartment pressure profile over time during the gripping process, a process logic that determines if, how, and when to modify or stop the execution of the gripping process and a set of parameters used in the said process logic.

According to the disclosure, the method further comprising the steps of before the gripper contacts the item to be picked, feeding the most recently generated gripping configuration to the picking system controller in addition to the captured geometry and after the gripper contacts the item to be picked, feeding the most recently generated gripping configuration to the picking system controller in addition to the on-gripper sensor readings.

According to the disclosure, a picking system comprising a gripper, a robotic manipulator to which the gripper is attached, at least one comprises controller, wherein the gripper further comprises a suction compartment delimited by the suction compartment wall, at least one actuator for modulating the position of the suction compartment wall at least one on-gripper sensor measuring the force experienced by the suction compartment wall and at least one gripper controller, which can be integrated with the picking system controller as one integrated controller or can comprise one or more separate controllers.

According to the disclosure, method of stopping the robotic manipulator using a picking system is disclosed. The method comprising the steps of before the gripper reaches the proximity of the item, do the follow steps in any order, setting a contact force threshold, using the actuator on the gripper to cause the suction compartment wall to extend towards the distal direction of the gripper by a distance relative to its initial position. This distance is equal to or greater than the distance needed for the robotic manipulator to decelerate, monitoring the force experienced by the suction compartment wall by reading the corresponding on-gripper sensor repeatedly in fixed or varying intervals, once the on-gripper sensor detects a compressive force experienced by suction compartment wall exceeding the contact force threshold (indicating the gripper is in contact with the item), or once the pick point is reached, do the following, one or more actuators on the gripper cause the suction compartment wall to retract towards the proximal direction of the gripper back to its initial position, sending a stop command to the robot and waiting for the robot to come to a full stop.

According to the disclosure, a further picking system is disclosed. The picking system comprises a gripper, a robotic manipulator to which the gripper is attached, at least one picking system controller. The gripper further comprises a suction compartment delimited by the suction compartment wall, at least one actuator for modulating the position of the suction compartment wall, at least one on-gripper sensor measuring the pressure in the suction compartment and at least one gripper controller, which can be integrated with the picking system controller as one integrated controller or can comprise one or more separate controllers.

According to the disclosure, a method of stopping the robotic manipulator using the picking system, comprising the steps of before the gripper reaches the proximity of the item, do the follow steps in any order, setting a pressure threshold, activating the pressure mechanism to attempt to lower the suction compartment pressure, using the actuator on the gripper to cause the suction compartment wall to extend towards the distal direction of the gripper by a distance compared to its initial position. This distance is equal to or greater than the distance needed for the robotic manipulator to decelerate, monitoring the pressure in the suction compartment by reading the corresponding on-gripper sensor repeatedly in fixed or varying intervals, once the on-gripper sensor detect that the pressure inside the suction compartment is lower than the pressure threshold (indicating a strong vacuum is established in the suction compartment), or once the pick point is reached, do the following, one or more actuator on the gripper causing the suction compartment wall to retract towards the proximal direction of the gripper back to its initial position, sending a stop command to the robot and waiting for the robot to come to a full stop.

According to the disclosure, a method of determining a pick point, using a picking system, the method comprising the steps of:
(a) using the sensor to capture the geometry of one or more items to be picked, along with the geometry of their surroundings,
(b) removing the portion of the captured geometry from step (a) representing the surroundings of the one or more items to be picked;
(c) extracting from the captured geometry after (b) a layer of geometry of a given thickness. The layer is extracted in a way such that the two planes that delimit the layer are perpendicular to the direction along which the gripper most likely approaches. One of the said planes touches the extracted geometry, and no part of the captured geometry after (b) is on the side of the plane in which the gripper may approach;
(d) projecting the layer of geometry onto a plane parallel to the layer, resulting in a projected geometry containing one or more two-dimensional geometric entities;
(e) eliminating outliner geometric entities and filling in holes and small gaps in the geometric entities in the projected geometry;
(f) removing from each geometric entity in the projected geometry obtained after step (e) a strip of a specific width on the edge;
(g) skeletonizing each geometric entity in the projected geometry obtained after step (e);
(h) checking if the projected geometry after step (f) is empty;
(i) If step (h) returns true, use a point in the captured geometry from step (a), which is corresponding to a randomly selected point in the projected geometry after step (f), as the pick point; and
(j) If step (h) returns false, use a point in the captured geometry from step (a), which is corresponding to a randomly selected point in the skeletonized projected geometry after step (g), as the pick point.

According to the disclosure, a method of determining the pick point using a picking system is disclosed. The method comprising the steps of:
(a) using the sensor to capture the geometry of one or more items to be picked along with the geometry of their surroundings;
(b) setting an initial pick point;
(c) setting an initial pick orientation;
(d) specifying a two-dimensional region of interest of specific shape and size;
(e) locating the center of the two-dimensional region of interest at the initial pick point and orient the two-dimensional region of interest such that it is perpendicular to the initial pick orientation;
(f) extracting from the captured geometry of step (a) the portion of geometry whose projection along the initial pick orientation onto a plane containing the two-dimensional region of interest falls inside the two-dimensional region of interest;
(g) from the portion of captured geometry extracted in step (f), identifying the point that is the furthest into the originating direction of the initial pick orientation;
(h) removing the portion of the extracted geometry in step (f) whose distance from the point extracted in step (g) along the initial pick orientation is more than a given threshold;
(i) projecting the remaining of the extracted geometry after step (h) onto the plane containing the two-dimensional region of interest, resulting in a projected geometry containing one or more two-dimensional geometric entities;
(j) eliminating outliner geometric entities and filling in holes and small gaps in the remaining geometric entities in the projected geometry;
(k) checking if the shape of the largest two-dimensional geometric entities in the projected geometry in step (j) has a length-to-width ration over a specific threshold, thus resembling a thin edge. If true, choosing the point in the part of the extracted geometry after step (h):
   that is the furthest into the originating direction of the initial pick orientation, and that is corresponding to the largest two-dimensional geometric entities in the projected geometry in step (j),
      as the pick point. If false, going on to step (I);
(l) from the extracted geometry after step (h), extracting a portion of the geometry that is of a specific size in terms of a spatial metric, and is the closest to the line though the initial picking point along the initial pick orientation; (the spatial metric can be any metrics that can be used to measure the size of a geometric entity, such as an area value in a 2D shape, a number of points in a point cloud, etc.); and
(m) choosing the point that is the furthest into the originating direction of the initial pick orientation in the geometry extracted in step (l) as the picking point.

According to the disclosure, a method of determining pick orientation using a picking system is disclosed. The method comprising the steps of:
(a) using the sensor to capture the geometry of one or more items to be picked along with the geometry of their surroundings;
(b) setting an initial pick orientation;
(c) specifying a two-dimensional region of interest of specific shape and size;
(d) locating the center of the two-dimensional region of interest at the pick point and orient the two-dimensional region of interest such that it is perpendicular to the initial pick orientation;
(e) extracting from the captured geometry in step (a) the portion whose projections along the initial pick orientation onto a plane containing the two-dimensional region of interest fall inside the two-dimensional region of interest;
(f) from the portion of captured geometry extracted in step (e), locating the point that is the furthest into the originating direction of the initial pick orientation;
(g) removing the portion of the extracted geometry in step (e) whose distance from the point extracted in step (f) along the initial pick orientation is more than a given first distance-from-the-top threshold;
(h) checking if the shape of the largest geometric entities in the remaining geometry in step (g) resembles a thin edge. If true, the pick orientation is the same as the initial pick orientation. If false, going on to step (i);
(i) estimating the normal direction of the remaining extracted geometry after step (g), referred to as the intermediate pick orientation;
(j) locating the center of the two-dimensional region of interest at the pick point and orient the two-dimensional region of interest such that it is perpendicular to the intermediate pick orientation;
(k) extracting from the captured geometry in step (a) the portion whose projections along the intermediate pick orientation onto a plane containing the two-dimensional region of interest fall inside the two-dimensional region of interest;
(l) from the portion of captured geometry extracted in step (k), locating the point that is the furthest into the originating direction of the intermediate pick orientation;
(m) removing the portion of the extracted geometry in step (k) whose distance from the point extracted in step (l) along the initial pick orientation is more than a given second distance-from-the-top threshold;
(n) projecting the remaining of the extracted geometry after step (m) onto the plane containing the two-dimensional region of interest, resulting in a projected geometry containing one or more two-dimensional geometric entities;
(o) eliminating outliner geometric entities and filling in holes and small gaps in the remaining geometric entities in the projected geometry;
(p) checking if the shape of the largest geometric entities in the projected geometry in step (o) resembles a thin edge. If true, the pick orientation is the same as the intermediate pick orientation. If false, going on to step (q);
(q) finding the centroid of the projected geometry of step (o);
(r) finding the point on the plane in step (n) through which the line through the pick point along the intermediate pick orientation passes;
(s) finding the distance between the centroid found in step (q) and the point found in step (r);
(t) adjusting the intermediate pick orientation in the following way to obtain the pick orientation:
   tilting the intermediate pick orientation in the direction pointing from the point found in step (r) to the centroid found in step (q); and
   the amount of tilting is a function of the distance between the point found in step (r) and the centroid found in (q).

### General Considerations

Implementations disclosed herein provide systems, methods and apparatus for generating or augmenting training data sets for machine learning training. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for the proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

1-41. (canceled)

42. A gripper system comprising:
a chamber compartment delimited by at least a chamber compartment wall;
a suction compartment delimited by a suction compartment wall;
a deformable membrane;
wherein the deformable membrane is attached to at least the chamber compartment wall and/or to the suction cup compartment wall.
at least one actuator for modulating the position of the chamber compartment wall and/or the position of the suction compartment wall;
at least one detecting element; and
an algorithm to detect one or more failures.

43. The gripper system of claim 42 wherein one or more pressure mechanisms can modulate the pressure within the suction cup compartment and/or the chamber compartment.

44. The gripper system of claim 43 wherein the pressure mechanism is a pump and/or an ejector and/or a venturi.

45. The gripper system of claim 42 wherein one or more detecting elements are selected from a list consisting of position, force, pressure, and image sensors, and their derivatives, such as velocity and acceleration sensors.

46. The gripper system of claim 42 wherein the algorithm is used for detecting one or more on-gripper failures wherein the failure is selected from a list consisting of membrane failure, mechanical component failure, actuator failure, pressure mechanism failure, sensor failure, controller failure.

47. The gripper system of claim 42 wherein the algorithm is used for detecting one or more gripper system failures wherein the failure is due to the collision between the gripper and one or more items outside the gripper.

48. The gripper system of claim 1, wherein the failure is detected from one or more control signals applied to one or more actuators and/or from one or more control signals applied to one or more pressure mechanisms and/or from one or more detecting element signals.

49. The gripper system of claim 1, wherein the failure is detected via monitoring the running performance and/or the expected response of the gripping system, including unexpected occurrence of unintentional dropping of one or more items.

50. The gripper system of claim 42 wherein the actuator to modulate the position of chamber compartment and/or the suction compartment is controlled by one or more controllers that control the position of the actuator over time.

51. A method of gripping an item, using a gripper system comprising:
a chamber compartment;
a suction compartment;
a membrane;
at least one pressure mechanism;
at least one actuator;
at least one detecting element; and
at least one controller;
the method comprising the steps of:
controlling the chamber compartment wall position over time if the chamber compartment wall is not fixed to the gripper body; and/or
controlling the suction compartment wall position over time if the suction compartment wall is not fixed to the gripper body; and/or
controlling the chamber compartment pressure over time; and/or
controlling the suction compartment pressure over time.

52. The method of claim 51 wherein the detecting element is selected from a list consisting of position, force, pressure, and image sensors.

53. The method of claim 51 further comprising the execution of one or more of the following functions during a gripping process:
information provided by one or more detecting element is processed to control the gripper operation during the gripping process; and/or
information provided by one or more detecting elements is processed to estimate the strength of the grip; and/or
the controller generates one or more control commands to adjust the control parameters to modulate the strength of the grip; and/or
information provided by one or more detecting element is processed to detect the unintentional dropping of one or more items.

54. The method in claim 51 wherein during a gripping process, one or more of the chamber compartment wall position, the suction compartment wall position, the chamber compartment pressure, and the suction compartment pressure, are controlled according to a gripping configuration that defines a set of process parameters of the gripping process.

55. The method of claim 54 wherein the set of process parameters is selected from a list consisting of position, velocity, acceleration, pressure, current, voltage, force, power, and electrostatic force.

56. The method of claim 54, wherein the gripping configuration comprises a set of process parameters selected from a list consisting of a profile of the chamber compartment wall position over time during the gripping process, a profile of the suction compartment wall position over time during the gripping, a profile of the chamber compartment pressure over time during the gripping process, and a profile of the suction compartment pressure over time during the gripping process.

57. The method in claim 56 wherein the gripping configuration comprises:
a process logic that determines at least a portion of the execution of the profiles comprising the steps of:
starting the gripping process following a gripping configuration comprising a number of position profiles and pressure profiles over time;
obtaining information through one or more detecting elements regarding one or more of the following values continuously: the suction compartment wall position, the chamber compartment wall position, the chamber compartment pressure, and the suction compartment pressure;
feeding the information obtained in the previous step to the process logic continuously or at intervals;
determining when, how, or whether to modify the gripping configuration currently being followed; and/or
determining when, how, or whether to stop the execution of the gripping process; and/or a set of parameters used in the said process logic.

58. The method of claim 56 wherein the gripping configuration comprises a chamber compartment wall position profile over time during the gripping process, a suction compartment wall position profile over time during the gripping process, a chamber compartment pressure profile over time during the gripping process, a suction compartment pressure profile over time during the gripping process, a process logic that decides about modifying or stopping the execution of the gripping process, and a set of parameters used in said process logic.

59. A method of determining the gripping configuration, using a gripping system comprising:
a chamber compartment;
a suction compartment;
a membrane;
at least one pressure mechanism;
at least one actuator;
at least one detecting element; and
at least one controller;
the method comprising the steps of:
starting the gripping process following a given default gripping configuration comprising a chamber compartment position and/or profile over time, and/or a suction compartment position and/or profile over time and/or chamber compartment pressure value and/or profile over time, and/or a suction compartment position value and/or profile over time;
monitoring the detecting element readings before the chamber position reaches a given threshold;
collecting data; and
once the chamber position reaches the given threshold, feeding the collected data to the controller to determine a gripping configuration.

60. The method of claim 59 wherein the step of collecting data further comprises collecting the maximum chamber compartment pressure reading between the time when the gripping process starts and the time when the chamber compartment wall position reaches the given threshold, the force experienced by the suction compartment wall when the chamber position reaches the given threshold, the chamber compartment pressure when the chamber compartment wall position reaches the given threshold and the suction compartment pressure when the suction compartment wall position reaches the given threshold.

61. The method of 59 wherein the step of collecting data further comprises collecting the profile of the chamber compartment pressure, and/or the profile of the suction compartment pressure; and/or the profile of the signals from one of more detecting element.
